(19) United States
(12) Patent Application Publication
(10) Pub. No.: US 2015/0299520 A1
(43) Pub. Date: Oct. 22, 2015

(54) ADHESIVE SHEET FOR IMAGE DISPLAY DEVICE, METHOD FOR MANUFACTURING IMAGE DISPLAY DEVICE, AND IMAGE DISPLAY DEVICE

(71) Applicant: HITACHI CHEMICAL COMPANY, LTD., Tokyo (JP)

(72) Inventors: Youichirou Mansei, Chikusei-shi, Ibaraki (JP); Kouji YAMAZAKI, Chikusei-shi, Ibaraki (JP); Tomoyuki nakamura, Chikusei-shi, Ibaraki (JP); Satoshi OHKAWA, Tsukuba-shi, Ibaraki (JP); Kazuo AIZU, Ichihara-shi, Ibaraki (JP); Katsunori HAYASHI, Ichihara-shi, Ibaraki (JP); Kenichi SHINYA, Ichihara-shi, Ibaraki (JP); Junichi IMAIZUMI, Chikusei-shi, Ibaraki (JP); Hiroaki TAKAHASHI, Chikusei-shi, Ibaraki (JP)

(73) Assignee: HITACHI CHEMICAL COMPANY, LTD., Tokyo (JP)

(21) Appl. No.: 14/435,580

(22) PCT Filed: Oct. 11, 2013
(86) PCT No.: PCT/JP2013/077840

§ 371 Date: Apr. 14, 2015

(30) Foreign Application Priority Data
Oct. 15, 2012 (JP) 2012-228255

(51) Int. Cl. C09J 7/02; C09J 133/08; B32B 7/12; B32B 27/08; B32B 37/18; B32B 37/12

(52) U.S. Cl. CPC C09J 7/0217; B32B 37/18; B32B 37/1284; B32B 7/12; B32B 27/08; C09J 133/08; B32B 2307/412; B32B 2457/202; B32B 2457/208; B32B 2551/00; B32B 2405/00; C09J 2433/00

(57) ABSTRACT

Provided is an adhesive sheet for an image display device (1), the adhesive sheet including a film-like adhesive layer (2), and a pair of substrate layers (3) and (4) laminated so as to interpose the adhesive layer (2) therebetween, in which the adhesive layer (2) contains a structural unit derived from stearyl (meth)acrylate as a main component, and has a haze value of 1.5% or less.

### TECHNICAL FIELD

The present invention relates to an adhesive sheet for an image display device, a method for manufacturing an image display device, and an image display device.

### BACKGROUND ART

In recent years, a method of suppressing decreases in the luminance and the contrast of an image display device by replacing the gap between a transparent protective plate or an information input device (for example, a touch panel) in the image display device and the display screen of the image display unit, or the gap between a transparent protective plate and an information input device, with a transparent material having a refractive index closer to that of the transparent protective plate, the information input device, and the display screen of the image display unit as compared with the refractive index of air, and thereby enhancing transmissivity (for example, Patent Literature 1). As an example of an image display device, an exemplary schematic diagram of a liquid crystal display device is illustrated in FIG. 24. The liquid crystal display device equipped with a touch panel is composed of a transparent protective plate (glass or plastic substrate) D1, a touch panel D2, a polarizing plate D3, and a liquid crystal display cell D4, and an adhesive layer D5 is provided between the transparent protective plate and the touch panel for the purpose of prevention of cracking of the liquid crystal display device, alleviation of stress and impact, and an enhancement of visibility. On some occasions, an adhesive layer D6 may be further provided between the touch panel and the polarizing plate.

However, it is necessary for the information input device and the image display unit to be provided with input and output wirings in their peripheral parts, and therefore, for the purpose of hiding these wirings from the transparent protective plate surface side, a decoration section D7 having a frame shape as illustrated in FIG. 25 is generally provided by printing or the like in the peripheral parts of the transparent protective plate (19 (frame pattern) in FIG. 1A of Patent Literature 1, or the like). In order to solve the problem of level difference generated by these decoration sections, for example, a film-like adhesive may be used as the adhesive for pasting the transparent protective plate. However, in order to embed the vicinity of this level difference without gaps, the film-like adhesive is required to have excellent level difference embeddability. In recent years, investigations have been conducted on various film-like adhesives for improving such level difference embeddability (for example, Patent Literature 2 and Patent Literature 3).

### CITATION LIST

### Patent Literature

Patent Literature 1: JP 2008-83491 A

Patent Literature 2: JP 2010-163591 A

Patent Literature 3: WO 2012/077806

### SUMMARY OF INVENTION

### Technical Problem

However, in regard to a film-like adhesives D9 described in Patent Literature 2 and Patent Literature 3, it has been made clear from the investigation of the inventors of the present invention that when the adhesive D9 is pasted to an adherend D8 having a level difference D7, the surface flatness at an area with a level difference and an area without a level difference is poor (Δt in FIG. 25 is large). If surface flatness is poor, it is expected that distortion occurs in the adhesive when the adhesive is pasted to an adherend such as a touch panel, causing display unevenness, and visibility may be deteriorated.

On the other hand, in recent years, electrostatic capacitive touch panels are frequently used in portable electronic terminals represented by mobile telephones. In an electrostatic capacitive touch panel, a capacitor that is formed between the touch panel and the fingertip plays an important role. When an adhesive layer is formed between a transparent protective plate and an electronic capacitive touch panel, since the dielectric constant of the adhesive layer is generally higher than that of air, there is a possibility that the electrostatic capacity of the capacitor formed between the touch panel and the fingertip is increased, and the workability may be affected. According to the results of the investigation conducted by the inventors of the present invention, it has been found that in a case in which an adhesive layer is interposed between a transparent protective plate and an electrostatic capacitive touch panel in an image display device or the like, from the viewpoint of workability of the electrostatic capacitive touch panel, the film-like adhesives described in Patent Literature 2 and Patent Literature 3 have high dielectric constants and are likely to be disadvantageous in design.

The present invention was achieved in view of such circumstances, and an object of the present invention is to provide an adhesive sheet for an image display device having an adhesive layer that has excellent embeddability for a level difference formed on an adherend, and also has excellent surface flatness, an appropriate value of dielectric constant, and excellent visibility. Another object of the present invention is to provide a method for manufacturing an image display device using the adhesive sheet for an image display device, and an image display device.

### Solution to Problem

The inventors of the present invention conducted a thorough investigation in order to solve the problems described above, and as a result, the inventors found that an adhesive sheet having an adhesive layer which is formed from an adhesive resin composition containing a structural unit derived from stearyl (meth)acrylate as a main component and has particular properties, can solve the problems described above. The present invention was completed based on such findings.

That is, the present invention provides an adhesive sheet for an image display device, the adhesive sheet including an adhesive layer and a pair of substrate layers laminated so as to interpose the adhesive layer therebetween, in which the adhesive layer contains a structural unit derived from stearyl (meth)acrylate as a main component and has a haze value of 1.5% or less.

With such an adhesive sheet for an image display device (hereinafter, may be simply referred to as “adhesive sheet”), storage and transportation of the adhesive sheet can be achieved easily without damaging the adhesive layer. Furthermore, since the adhesive layer contains a structural unit derived from stearyl (meth)acrylate as a main component, both the level difference embeddability and the suppression of bleed-out occurring when the adhesive sheet is pasted to an adherend and then left to stand still can be achieved.

The present invention also provides an adhesive sheet for an image display device, the adhesive sheet including an adhesive layer; a first substrate layer and a second substrate layer laminated so as to interpose the adhesive layer therebetween; and a carrier layer further laminated on the second substrate layer, in which the outer edges of the first substrate layer and the carrier layer are protruding outward compared with the outer edges of the adhesive layer, and the adhesive layer contains a structural unit derived from stearyl (meth)acrylate and has a haze value of 1.5% or less.

According to such an adhesive sheet, it is preferable that the outer edges of the first substrate layer and the carrier layer that constitute outer layers are protruding outward compared with the outer edges of the adhesive layer that constitute an inner layer. Thereby, the outer edge portions of the adhesive layer are securely protected on the occasions of storage, transportation and the like of the adhesive sheet. Furthermore, when the adhesive layer is attached to an adherend, the carrier layer can be easily detached from the second substrate layer by picking up the outer edge portion of the carrier layer that is protruding outward. Next, the first substrate layer can be easily detached by picking up the outer edge portion of the first substrate layer. At this time, since the second substrate layer remains on one side of the adhesive layer, when one surface of the adhesive layer is attached to the adherend, protection of the adhesive layer by this second substrate layer is maintained. Thereafter, the second substrate layer is detached, and the other surface of the adhesive layer is attached to another adherend. Thereby, the adhesive layer can be disposed between a pair of adherends.

The thickness of the adhesive layer in such an adhesive sheet is preferably 1.0×10² μm to 5.0×10² μm. Thereby, the adhesive sheet acquires excellent impact resistance and visibility.

Furthermore, the tan δ value at 40° C. to 80° C. of the adhesive layer in such an adhesive sheet is preferably 1.2 to 2. Thereby, the adhesive sheet acquires excellent level difference embeddability and surface flatness.

In addition, it is preferable that the adhesive layer in such an adhesive sheet is formed from a adhesive resin composition comprising (A) an acrylic acid derivative polymer, (B) an acrylic acid derivative, (C) a crosslinking agent, and (D) a photopolymerization initiator, in which the (A) acrylic acid derivative polymer contains a structural unit derived from stearyl (meth)acrylate, and the (B) acrylic acid derivative comprises stearyl (meth)acrylate.

The present invention provides a method for manufacturing an image display device, the method including a process of bonding adherends through the adhesive layer that is carried by the adhesive sheet and thereby obtaining a laminate; a process of subjecting the laminate to a heating and pressuring treatment under the conditions of 40° C. to 80° C. and 0.3 MPa to 0.8 MPa; and a process of irradiating the laminate with ultraviolet radiation through any one side of the adherends.

When the adhesive sheet of the present invention is used it is possible to bond together an image display unit and another member (optical member or the like) that is considered to be needed in the image display device, for example, an image display unit and a touch panel of a liquid crystal display unit or the like, the same image display unit and a transparent protective plate, or the touch panel and the transparent protective plate. In addition, the present invention can be particularly suitably used in a case in which the adherends are a transparent protective plate and a touch panel, or a transparent protective plate and an image display unit. Similarly, when the adhesive sheet of the present invention is used, it is also possible to bond the members that are closer to the visible side than the image display unit of an image display device. At that time, for example, even if the transparent protective plate on the visible side has a level difference along the peripheral edges, the adhesive layer can reliably embed the level difference. Also, since the adhesive sheet has excellent surface flatness in the vicinity of the level difference, visibility is not deteriorated.

Furthermore, the present invention provides an image display device comprising a laminate, the laminate comprising an image display unit, a transparent protective plate, and an adhesive layer that is disposed between the image display unit and the transparent protective plate, wherein the adhesive layer contains a structural unit derived from stearyl (meth)acrylate as a main component and has a haze value of 1.5% or less.

The present invention also provides an image display device comprising a laminate, the laminate comprising an image display unit, a touch panel, a transparent protective plate, and an adhesive layer that is disposed between the touch panel and the transparent protective plate, wherein the adhesive layer contains a structural unit derived from stearyl (meth)acrylate as a main component and has a haze value of 1.5% or less. Since the adhesive layer has excellent level difference embeddability and surface flatness, the adhesive layer is particularly suitable in a case in which a transparent protective plate has a level difference.

Such an image display device of the present invention has both excellent impact resistance and excellent visibility.

### Advantageous Effects of Invention

According to the present invention, an adhesive sheet for an image display device, which has excellent embeddability for a level difference formed on an adherend, has excellent surface flatness and an appropriate value of dielectric constant, and also has excellent visibility, can be provided. Furthermore, the present invention can also provide a method for manufacturing an image display device using such an adhesive sheet, and an image display device.

### BRIEF DESCRIPTION OF DRAWINGS

FIG. 1 is a perspective view illustrating an embodiment of the adhesive sheet (three-layered product) related to the present invention.

FIG. 2 is a cross-sectional illustrating an embodiment of the adhesive sheet (three-layered product) related to the present invention.

FIG. 3 is a cross-sectional view of a base material film.

FIG. 4 is a cross-sectional view illustrating a process of cutting a base material film.

FIG. 5 is a cross-sectional view illustrating a process of eliminating unnecessary parts of a base material film.

FIG. 6 is a cross-sectional view illustrating a process of eliminating a tentative separator.

FIG. 7 is a cross-sectional view illustrating a process of adding a light-to-release separator.

FIG. 8 is a cross-sectional view illustrating an embodiment of an image display device.

FIG. 9 is a cross-sectional view illustrating an embodiment of an image display device.

FIG. 10 is a cross-sectional view illustrating a process of detaching a light-to-release separator.

FIG. 11 is a cross-sectional view illustrating a process of adding an adhesive surface to an adherend.

FIG. 12 is a cross-sectional view illustrating a process of detaching a heavy-to-release separator.

FIG. 13 is a cross-sectional view illustrating a process of adding an adhesive surface to an adherend.

FIG. 14 is a perspective view illustrating an embodiment of an adhesive sheet (four-layered product) related to the present invention.

FIG. 15 is a lateral view illustrating an embodiment of an adhesive sheet (four-layered product) related to the present invention.

FIG. 16 is a cross-sectional view of a base material film.

FIG. 17 is a cross-sectional view illustrating a process of cutting a base material film.

FIG. 18 is a cross-sectional view illustrating a process of eliminating unnecessary parts of a base material film.

FIG. 19 is a cross-sectional view illustrating a process of eliminating unnecessary parts of a base material film.

FIG. 20 is a cross-sectional view illustrating a process of eliminating a tentative.

FIG. 21 is a cross-sectional view illustrating a process of adding a light-to-release separator.

FIG. 22 is a cross-sectional view illustrating a process of detaching a carrier film.

FIG. 23 is a schematic view illustrating a sample measurement method using a wide range dynamic viscoelasticity analyzer.

FIG. 24 is a cross-sectional view illustrating an embodiment of an image display device.

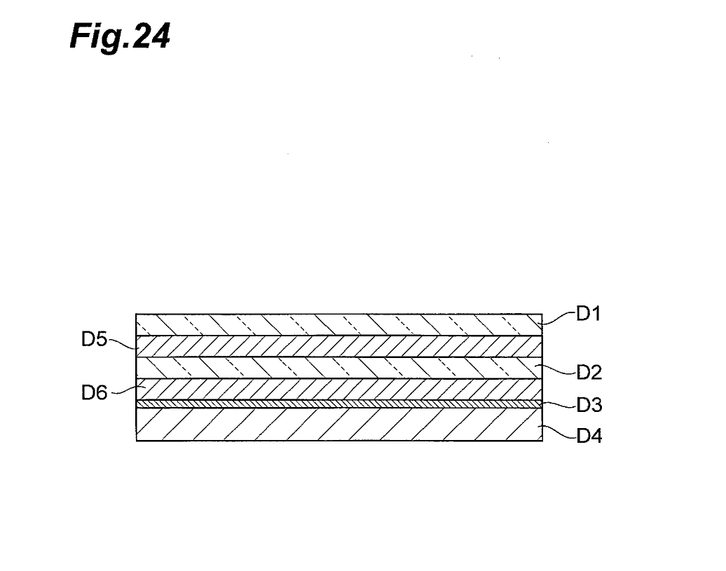

FIG. 25 is a schematic diagram illustrating surface flatness on the occasion of using a conventional adhesive sheet.

### DESCRIPTION OF EMBODIMENTS

Hereinafter, suitable embodiments (first embodiment and second embodiment) of the present invention are described, but the present invention is not intended to be limited to these embodiments. In addition, the descriptions that are overlapping in both embodiments will be described only in the first embodiment, and the same descriptions will be omitted in the explanation of the second embodiment accordingly. Furthermore, the term “(meth)acrylate” in the present specification means an “acrylate” and a “methacrylate” corresponding thereto. As such, “(meth)acryl” means an “acryl” and a “methacryl” corresponding thereto, and “(meth)acryloyl” means an “acryloyl” and a “methacryloyl” corresponding thereto.

### First Embodiment

<Adhesive Sheet for Image Display Device I>

The adhesive sheet for an image display device of the present embodiment comprises an adhesive layer and a pair of substrate layers laminated so as to interpose the adhesive layer therebetween. It is preferable that the outer edges of the substrate layers are protruding outward relative to the outer edges of the adhesive layer.

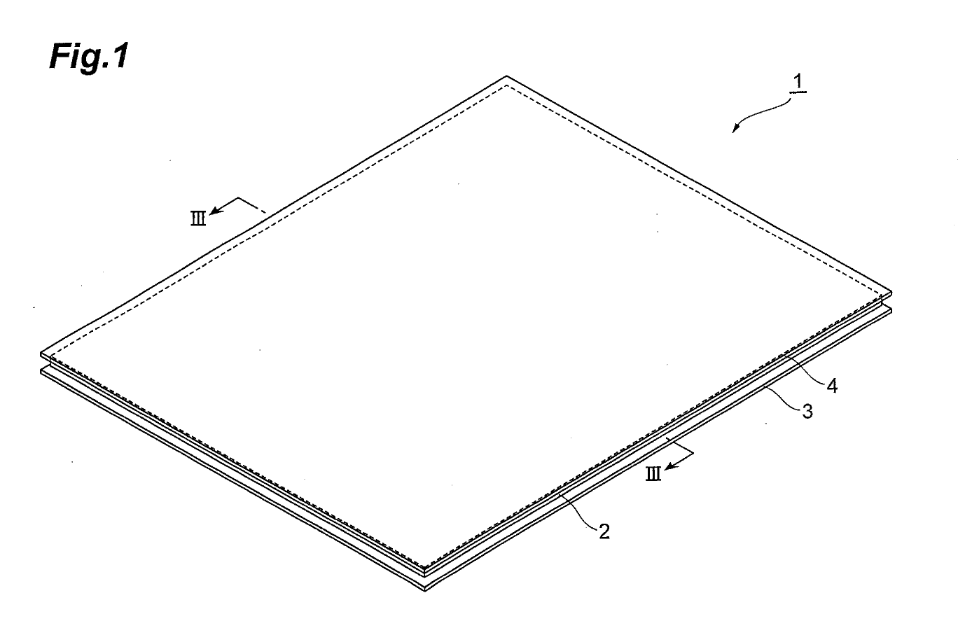

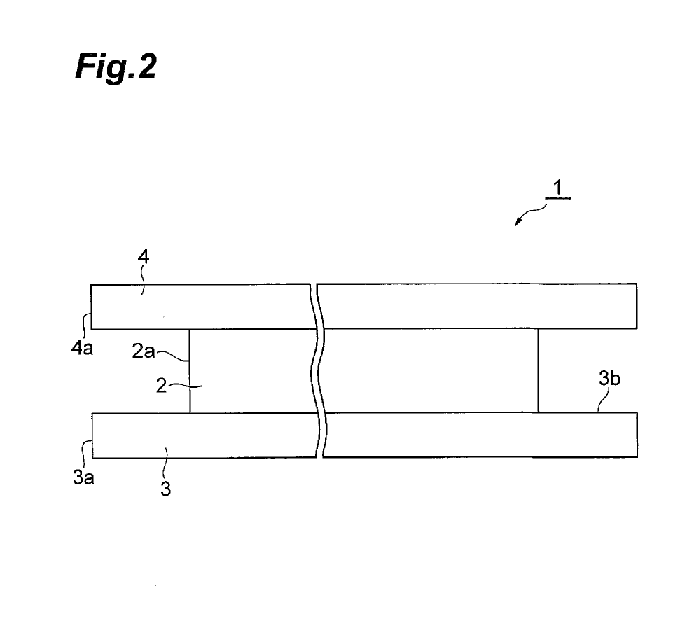

That is, as illustrated in FIG. 1 and FIG. 2, an adhesive sheet 1 (three-layered product) according to the present embodiment comprises an adhesive layer 2 in the form of a transparent film, and a heavy-to-release separator 3 (one of the substrate layers) and a light-to-release separator 4 (the other substrate layer) that interpose the adhesive layer 2 therebetween. This adhesive layer 2 is, for example, a transparent film that is disposed between a transparent protective plate and a touch panel, or between a touch panel and a liquid crystal display unit, in an image display device such as a touch panel type display for portable terminals.

The adhesive layer 2 is formed from an adhesive resin composition containing a structural unit derived from stearyl (meth)acrylate as a main component. For this reason, the adhesive layer has superior surface flatness in addition to the adhesive force, and provides an effect that can adjust the dielectric constant to an appropriate value.

In the adhesive layer 2, the structural unit derived from stearyl (meth)acrylate may be a structural unit originating from a polymer component that constitutes the adhesive resin composition, or may be a structural unit originating from a monomer component. That is, the relevant structural unit may be given into the adhesive resin composition by incorporating a skeleton derived from stearyl (meth)acrylate into the polymer component, or the relevant structural unit may be given by comprising stearyl (meth)acrylate among the monomer components. However, it is preferable that the relevant structural unit originates from both a polymer component and a monomer component, from the viewpoint of increasing transparency of the adhesive layer 2.

The structural unit derived from stearyl (meth)acrylate is a main component of the adhesive layer 2. The main component for the present invention means a component which is available in the largest amount among the components that constitute the adhesive layer 2.

The content of the structural unit derived from stearyl (meth)acrylate is preferably 50% by mass or more, more preferably 60% by mass or more, and even more preferably 70% by mass or more relative to the total mass, from the viewpoints of surface flatness and a decrease in the dielectric constant. From the same viewpoints, the same content is preferably 95% by mass or less, more preferably 90% by mass or less, and even more preferably 85% by mass or less.

It is preferable that the adhesive layer 2 has the properties described below. That is, the adhesive layer 2 needs to have a haze value of 1.5% or less in order to be used in an image display device. From the viewpoint of visibility, the haze value is preferably 1.0% or less, more preferably 0.8% or less, and even more preferably 0.5% or less. Regarding the lower limit of the haze, it is preferable that the haze value is closer to 0%; however, the haze value is usually larger than 0%, and from the viewpoint of practical use, the haze value is 0.1% or more.

The haze is dependent on the compatibility between the component (A), component (B) and component (C) described below. When the compatibility between the component (A), component (B) and component (C) is favorable, the haze value can be lowered. Examples of the method of adjusting the haze value to 1.5% or less include the following methods.

1) In a case in which stearyl (meth)acrylate is incorporated into the structural unit as a main component of the component (A) described below, a compound having a polar group, such as a hydroxyl group-containing (meth)acrylate or an alkylene glycol chain-containing (meth)acrylate is not selected as the component (B), or if selected, the content of the compound is reduced.

2) In a case in which stearyl (meth)acrylate is incorporated into the structural unit as a main component of the component (A) described below, and a high molecular weight component (having a weight average molecular weight of 2.0×10³ or more) is used as the component (C), a compound primarily containing an alkyl group or alkylene group having 9 to 18 carbon atoms is selected as the component (C).

3) In a case in which stearyl (meth)acrylate is incorporated into the structural unit as a main component of the component (A) described below, a low molecular weight component (having a weight average molecular weight of less than 2.0×10³) is selected as the component (C).

The haze is a value (%) representing turbidity, and is determined from the total transmittance T of the light that has been irradiated by a lamp and transmitted through a sample and the transmittance D of the light that has been diffused in the sample and scattered away, by the formula: (D/T)×100. These values are defined by JIS K 7136, and the haze can be easily measured using a commercially available turbidimeter, for example, an NDH-5000 manufactured by Nippon Denshoku Industries Co., Ltd.

Furthermore, in regard to the adhesive layer 2, from the viewpoint of enhancing the level difference embeddability and surface flatness, the tan δ value at 40° C. to 80° C. is preferably 1.2 or more, more preferably 1.3 or more, and even more preferably 1.4 or more. On the other hand, from the viewpoint of obtaining satisfactory film forming properties, the adhesive layer 2 is such that the tan δ value at 40° C. to 80° C. is preferably 2 or less, more preferably 1.9 or less, and even more preferably 1.8 or less.

Here, the tan δ is a value obtained by dividing the loss modulus by the shear storage modulus, and the loss modulus and the shear storage modulus are values measured using a wide range dynamic viscoelasticity analyzer. The glass transition temperature (Tg), loss modulus and shear storage modulus are specifically measured by the following method.

(Measurement of Glass Transition Temperature, Loss Modulus, and Shear Storage Modulus)

The glass transition temperature, loss modulus, and shear storage modulus can be obtained by producing an adhesive layer having a thickness of 0.5 mm, a width of 10 mm, and a length of 10 mm, and measuring the relevant properties using a wide range dynamic viscoelasticity analyzer (manufactured by Rheometric Scientific, Inc. Solids Analyzer RSA-II) under the conditions of “shear sandwich mode, frequency: 1.0 Hz, measurement temperature range: −20° C. to 100° C., and a rate of temperature increase: 5° C./min”.

The adhesive layer 2 is such that the shear storage modulus at 25° C. is preferably 5.0×10⁴ Pa or more, and more preferably 8.0×10⁴ Pa or more. Furthermore, in regard to the adhesive layer 2, the shear storage modulus at 25° C. is preferably 5.0×10⁵ Pa or less, and more preferably 3.5×10⁵ Pa or less. When the shear storage modulus at 25° C. is adjusted to be within this range, the level difference embeddability and the bleeding properties can be further enhanced.

Furthermore, the glass transition temperature of the adhesive layer 2 is preferably 0° C. or higher, more preferably 10° C. or higher, and even more preferably 20° C. or higher. When the glass transition temperature is 0° C. or higher, the bleeding properties can be further suppressed, and on the occasion of detaching the light-to-release separator 4 that will be described below, the light-to-release separator is easily and satisfactorily detached so that the film-forming properties tend to be maintained satisfactorily. On the other hand, the glass transition temperature of the adhesive layer 2 is preferably 50° C. or lower, and more preferably 45° C. or lower. When the glass transition temperature is 50° C. or lower, adhesiveness and the level difference embeddability tend to be increased. Meanwhile, the glass transition temperature according to the present invention is defined as the temperature at which tan δ exhibits a peak in the measurement temperature range described above. However, when two or more tan δ peaks are observed in this temperature range, the temperature at which the tan δ has the largest value is defined as the glass transition temperature.

The thickness of the adhesive layer 2 is not particularly limited because the thickness may be adjusted according to the use applications and methods accordingly; however, the thickness is preferably 1.0×10² μm or more, more preferably 1.2×10² μm or more, and even more preferably 1.3×10² μm or more. Furthermore, the thickness is preferably 5.0×10² μm or less, more preferably 3.5×10² μm or less, and even more preferably 3.0×10² μm or less. When the thickness is used in this range, the adhesive sheet exhibits a particularly excellent effect as a transparent adhesive sheet for bonding an optical member onto a display.

Furthermore, when the adhesive layer 2 is used between a touch panel and a transparent protective plate, the dielectric constant of the adhesive layer at 100 kHz at room temperature (25° C.) is preferably 2 or more from the viewpoint of securing the responsiveness of the touch panel. On the other hand, from the viewpoint of reducing the possibility that too high responsiveness may cause malfunction, the dielectric constant is preferably 4 or less, more preferably 3.5 or less, and even more preferably 3.2 or less.

Furthermore, the adhesive layer 2 is formed by, for example, applying an adhesive resin composition containing the stearyl (meth)acrylate component and a component having a (meth)acryloyl group that is optionally added, to an arbitrary thickness on a heavy-to-release separator 3, irradiating this adhesive resin composition with active energy radiation to cure the composition, and then cutting the cured product to a desired size. The light source for the active energy radiation is preferably a light source having a light emission distribution at a wavelength of 400 nm or less, and for example, a low pressure mercury lamp, a medium pressure mercury lamp, a high pressure mercury lamp, an ultrahigh pressure mercury lamp, a chemical lamp, a black light lamp, a metal halide lamp, and a microwave-excited mercury lamp can be used. Furthermore, although there are no particular limitations, the irradiation energy is preferably 1.6×10² mJ/cm² or more, more preferably 1.8×10² mJ/cm² or more, and even more preferably 2.0×10² mJ/cm² or more. Moreover, the irradiation energy is preferably 6.5×10² mJ/cm² or less, more preferably 6.0×10² mJ/cm² or less, and even more preferably 5.0×10² mJ/cm² or less.

It is preferable that the adhesive resin composition comprises (A) an acrylic acid derivative polymer, (B) an acrylic acid derivative, (C) a crosslinking agent, and (D) a photopolymerization initiator.

Hereinafter, the adhesive resin composition will be described.

[Component (A): (A) Acrylic Acid Derivative Polymer]

The (A) acrylic acid derivative polymer refers to a compound obtained by polymerizing a monomer having one (meth)acryloyl group in the molecule, or copolymerizing two or more kinds of such monomers in combination. Meanwhile, to the extent that the effects by the present embodiment are not impaired, the component (A) may also be a product obtained by copolymerizing a compound having two or more (meth)acryloyl groups in the molecule, or a polymerizable compound that does not have any (meth)acryloyl group (a compound having one polymerizable unsaturated bond in the molecule, such as acrylonitrile, styrene, vinyl acetate, ethylene, or propylene; or a compound having two or more polymerizable unsaturated bonds in the molecule, such as divinylbenzene), with a (meth)acrylic acid-based derivative polymer.

Examples of the monomer having one (meth)acryloyl group in the molecule, which forms the component (A), include (meth)acrylic acid; (meth)acrylic acid amide; (meth)acryloylmorpholine; an alkyl (meth)acrylate with an alkyl group having 1 to 18 carbon atoms, such as methyl (meth)acrylate, ethyl (meth)acrylate, n-butyl (meth)acrylate, isobutyl (meth)acrylate, t-butyl (meth)acrylate, n-pentyl (meth)acrylate, n-hexyl (meth)acrylate, n-octyl (meth)acrylate, isooctyl (meth)acrylate, 2-ethylhexyl (meth)acrylate, isodecyl (meth)acrylate, dodecyl (meth)acrylate (n-lauryl (meth)acrylate), or stearyl (meth)acrylate; a (meth)acrylate having an aromatic ring, such as benzyl (meth)acrylate or phenoxyethyl (meth)acrylate; a (meth)acrylate having an alicyclic group, such as cyclohexyl (meth)acrylate, isobornyl (meth)acrylate, or dicyclopentanyl (meth)acrylate; tetrahydrofurfuryl (meth)acrylate; N,N-dimethylaminoethyl (meth)acrylate; a (meth)acrylamide derivative such as N,N-dimethylaminopropyl (meth)acrylamide, N,N-dimethyl (meth)acrylamide, N-isopropyl (meth)acrylamide, N,N-diethyl (meth)acrylamide, or N-hydroxyethyl (meth)acrylamide; a (meth)acrylate having an isocyanate group, such as 2-(2-methacryloyloxyethyloxy)ethyl isocyanate, or 2-(meth)acryloyloxyethyl isocyanate; and an alkylene glycol chain-containing (meth)acrylate.

It is preferable that the component (A) contains stearyl (meth)acrylate as a monomer component. In a case in which the component (A) is a copolymer, the content proportion of stearyl (meth)acrylate is preferably 50% by mass or more, more preferably 60% by mass or more, and even more preferably 70% by mass or more, relative to the total mass of the copolymer. Furthermore, the content proportion is preferably 98% by mass or less, more preferably 95% by mass or less, and even more preferably 90% by mass or less. When the content proportion of stearyl (meth)acrylate is in such a range, adhesiveness between the adhesive layer and a transparent protective plate (a glass substrate, a plastic substrate or the like), and surface flatness are further enhanced, and the dielectric constant can be further reduced. Such a copolymer can be generally obtained by blending various monomers at proportions such as the content proportions described above, and copolymerizing the monomers. Also, it is more preferable to adjust the rate of polymerization to be substantially close to 100%.

Examples of stearyl(meth)acrylate include n-stearyl(meth)acrylate (also called octadecyl(meth)acrylate) and isostearyl(meth)acrylate; however, among them, isostearyl(meth)acrylate is more preferred. It is particularly preferable that the number of branches of the isostearyl group in the isostearyl (meth)acrylate is larger. These stearyl (meth)acrylates may be used in combination of two or more kinds.

The other monomer to be copolymerized with stearyl(meth)acrylate is not intended to be limited to those described above; however, monomers having polar groups, such as a hydroxyl group, a morpholino group, an amino group, a carboxyl group, a cyano group, a carbonyl group, a nitro group and an alkylene glycol-derived group, are preferred. (Meth)acrylates having these polar groups allow an increase in the adhesiveness between the adhesive layer and the transparent protective plate, and also an increase in reliability under high temperature high humidity conditions.

Particularly, it is preferable to use stearyl(meth)acrylate in combination with an alkylene glycol chain-containing (meth)acrylate represented by the following formula (x):

CH₂═CXCOO(CₚH₂ₚO)_{q}R (x)

wherein in formula (x), X is a hydrogen atom or a methyl group; R is a hydrogen atom or an alkyl group having 1 to 10 carbon atoms; p is an integer from 2 to 4; and q is an integer from 1 to 10.

Examples of the alkylene glycol chain-containing (meth)acrylate represented by formula (x) include hydroxyl group-containing (meth)acrylates such as 2-hydroxyethyl(meth)acrylate, 1-hydroxyethyl(meth)acrylate, 2-hydroxypropyl(meth)acrylate, 3-hydroxypropyl(meth)acrylate, 1-hydroxypropyl(meth)acrylate, 4-hydroxybutyl(meth)acrylate, 3-hydroxybutyl(meth)acrylate, 2-hydroxybutyl(meth)acrylate, and 1-hydroxybutyl(meth)acrylate; polyethylene glycol mono(meth)acrylates such as diethylene glycol mono(meth)acrylate, triethylene glycol mono(meth)acrylate, tetraethylene glycol mono(meth)acrylate, and hexaethylene glycol mono(meth)acrylate; polypropylene glycol mono(meth)acrylates such as dipropylene glycol mono(meth)acrylate, tripropylene glycol mono(meth)acrylate, and octapropylene glycol mono(meth)acrylate; polybutylene glycol mono(meth)acrylates such as dibutylene glycol mono(meth)acrylate and tributylene glycol mono(meth)acrylate; methoxy-polyethylene glycol(meth)acrylates such as methoxytriethylene glycol(meth)acrylate, methoxytetraethylene glycol(meth)acrylate, methoxyhexaethylene glycol(meth)acrylate, methoxyoctaethylene glycol(meth)acrylate, and methoxynonaethylene glycol(meth)acrylate; and alkoxy-polyalkylene glycol(meth)acrylates such as methoxyheptapropylene glycol(meth)acrylate, ethoxytetraethylene glycol(meth)acrylate, butoxyethylene glycol(meth)acrylate, and butoxydiethylene glycol(meth)acrylate. Among these, 2-hydroxyethyl(meth)acrylate, 1-hydroxyethyl(meth)acrylate, 2-hydroxypropyl(meth)acrylate, 3-hydroxypropyl(meth)acrylate, 1-hydroxypropyl(meth)acrylate, 4-hydroxybutyl(meth)acrylate, 3-hydroxybutyl(meth)acrylate, 2-hydroxybutyl(meth)acrylate, and 1-hyroxybutyl(meth)acrylate are preferred; 2-hydroxyethyl(meth)acrylate and 4-hydroxybutyl(meth)acrylate are more preferred; and 2-hydroxyethyl(meth)acrylate is even more preferred. Also, these alkylene glycol chain-containing (meth)acrylates may be used in combination of two or more kinds thereof.

In regard to the weight average molecular weight of the component (A), the value calculated using a calibration curve of polystyrene standards by gel permeation chromatography (GPC) is preferably 1.5×10⁴ or more, more preferably 2.0×10⁴ or more, and even more preferably 2.5×10⁴ or more. When the weight average molecular weight of the same component is 1.5×10⁴ or more, an adhesive layer having an adhesive force that makes peeling to occur with difficulties from the transparent protective plate or the like, can be obtained. On the other hand, the weight average molecular weight of the same component is preferably 3.0×10⁵ or less, more preferably 2.0×10⁵ or less, and even more preferably 1.0×10⁵ or less. When the weight average molecular weight of the same component is 3.0×10⁵ or less, the viscosity of the adhesive resin composition is not excessively increased, and processability at the time of producing a sheet-like adhesive layer becomes more satisfactory.

Regarding the method for polymerizing the component (A), known polymerization methods such as solution polymerization, emulsion polymerization, suspension polymerization, and bulk polymerization can be used.

As the polymerization initiator that may be used when the component (A) is polymerized, a compound which generates a radical under heating can be used. Specific examples thereof include organic peroxides such as benzoyl peroxide, lauroyl peroxide, and t-butyl peroxy-2-ethylhexanoate; and azo-based compounds such as 2,2′-azobisisobutyronitrile and 2,2′-azobis(2-methylbutyronitrile).

The content of the component (A) is preferably 30% by mass or more, more preferably 40% by mass or more, and even more preferably 45% by mass or more, relative to the total mass of the adhesive resin composition. Furthermore, the content of the same component is preferably 90% by mass or less, more preferably 80% by mass or less, and even more preferably 70% by mass or less, relative to the total mass of the adhesive resin composition. When the content of the component (A) is in this range, the viscosity of the adhesive resin composition falls in an appropriate viscosity range for producing the adhesive layer, and processability becomes more satisfactory. Furthermore, the resulting adhesive layer has further improved adhesiveness to a transparent protective plate such as a glass substrate or a plastic substrate, and improved surface flatness.

[Component (B): Acrylic Acid Derivative]

The (B) acrylic acid derivative is a (meth)acrylic acid-based derivative monomer having one (meth)acryloyl group in the molecule, and examples thereof include the compounds exemplified as the monomer having one (meth)acryloyl group in the molecule, which forms the component (A).

Meanwhile, according to the present embodiment, from the viewpoints of adhesiveness, transparency, level difference embeddability and bleeding properties, the component (B) preferably contains stearyl (meth)acrylate, and from the viewpoints of surface flatness and a decrease in dielectric constant, isostearyl (meth)acrylate is more preferred. Furthermore, from the viewpoints of adhesiveness, transparency, and reliability under high temperature and high humidity conditions, it is even more preferable that the component (B) comprises a hydroxyl group-containing (meth)acrylate. Among the hydroxyl group-containing (meth)acrylates, particularly, 4-hydroxybutyl(meth)acrylate is particularly preferred.

The content of the component (B) is preferably 5% by mass or more, more preferably 15% by mass or more, and even more preferably 25% by mass or more, relative to the total mass of the adhesive resin composition. Furthermore, the content of the same component is preferably 65% by mass or less, more preferably 55% by mass or less, and even more preferably 45% by mass or less, relative to the total mass of the adhesive resin composition. When the content of the component (B) is in this range, the viscosity of the adhesive resin composition falls in an appropriate viscosity range for producing an adhesive layer, and processability becomes more satisfactory. Furthermore, the resulting adhesive sheet acquires superior adhesiveness and transparency. Then, the resulting adhesive layer also acquires superior level difference embeddability.

In the case of using stearyl(meth)acrylate as the component (B), the content of stearyl(meth)acrylate is preferably 5% by mass or more, more preferably 15% by mass or more, and even more preferably 25% by mass or more, relative to the total mass of the adhesive resin composition, from the viewpoint of enhancing adhesiveness, transparency, level difference embeddability and surface flatness in a well-balanced manner. From the same points of view, in the case of using stearyl (meth)acrylate as the component (B), the content thereof is preferably 60% by mass or less, more preferably 50% by mass or less, and even more preferably 45% by mass or less.

In the case of using a hydroxyl group-containing (meth)acrylate as the component (B), the content of the hydroxyl group-containing (meth)acrylate is preferably 1% by mass or more, more preferably 2% by mass or more, and even more preferably 3% by mass or more, relative to the total mass of the adhesive resin composition, from the viewpoint that adhesive can be further increased, while the haze can be further decreased. From the same point of view, in the case of using a hydroxyl group-containing (meth)acrylate as the component (B), the content thereof is preferably 15% by mass or less, more preferably 10% by mass or less, and even more preferably 8% by mass or less.

[Component (C): (C) Crosslinking Agent]

The component (C) is a compound having a bifunctional or higher-functional compound having a (meth)acryloyl group, and specific suitable examples of the component (C) comprise compounds represented by the following formulas (c) to (e), a urethane di(meth)acrylate having a urethane bond, a side chain (meth)acryl-modified (meth)acrylate polymer, trimethylolpropane tri(meth)acrylate, tetramethylolmethane tri(meth)acrylate, tetramethylolmethane tetra(meth)acrylate, dipentaerythritol penta(meth)acrylate, and dipentaerythritol hexa(meth)acrylate. However, in the formulas (c), (d) and (e), s is an integer from 1 to 20.

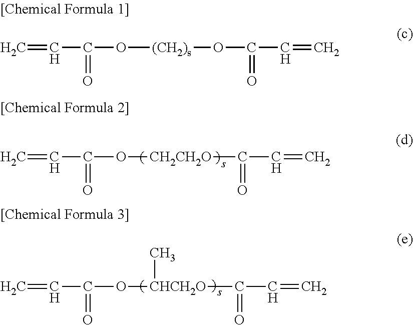

In the case of using a compound represented by the above formula (c), s is preferably 6 or more, and more preferably 9 or more, from the viewpoint that the haze can be further decreased. From the same point of view, in the case of using a compound represented by the above formula (c), s is preferably 18 or less. In the case of using compounds represented by the above formula (d) and formula (e), s is preferably 1 or more from the viewpoint that the haze can be further decreased. From the same point of view, in the case of using compounds represented by the above formula (d) and formula (e), s is preferably 10 or less, and more preferably 8 or less.

When the urethane di(meth)acrylate having a urethane bond is a compound which has been synthesized using a polyalkylene glycol having 2 to 4 carbon atoms and has a weight average molecular weight of 1.0×10³ or more, the compound tends to have poor compatibility with stearyl(meth)acrylate and a copolymer containing stearyl(meth)acrylate as a main component. Due to such tendency, in order to adjust the haze value to 1.5% or less, it is preferable that a urethane di(meth)acrylate having a urethane bond, which has been synthesized using a polyalkylene glycol having 2 to 4 carbon atoms, is substantially not incorporated, or is used at a reduced content and used in combination with other components (C).

The side chain (meth)acryl-modified (meth)acrylate polymer may be any (meth)acrylate polymer having its side chains modified with (meth)acryloyl groups. However, from the viewpoints of level difference embeddability and surface flatness, a polymer having a structural unit represented by the following general formula (1) and a structural unit represented by the following general formula (2) is preferred, and from the viewpoints of haze, level difference embeddability and surface flatness, R¹ in the following general formula (1) is an alkyl group having 9 to 18 carbon atoms. From these viewpoints, the side chain (meth)acryl-modified (meth)acrylate polymer is more preferably such that the (meth)acrylate polymer before modification is the component (A). When the component (C) is obtained by subjecting the component (A) to (meth)acrylic modification of the side chains, far superior compatibility between the component (A) and the component (C) is obtained, and thereby, an adhesive sheet having a small haze value and superior surface flatness can be obtained.

Regarding the method for the (meth)acrylic modification of side chains, there is available a method of incorporating, for example, a structural unit having a hydroxyl group as represented by the following general formula (3) or a structural unit having a carboxyl group to the component (A) in the main chain of the polymer, and adding thereto a (meth)acrylate having an isocyanate group, such as 2-isocyanatoethyl(meth)acrylate represented by the following general formula (4). Another example of the method is a method of incorporating a structural unit having a glycidyl group represented by the following general formula (5) into the main chain of the polymer, and adding (meth)acrylic acid thereto. Furthermore, there is also available a method of forming (meth)acrylic side chains by graft polymerization using dibutyltin dilaurate or the like; however, a method of adding a (meth)acrylate having an isocyanate group such as 2-isocyanatoethyl(meth)acrylate to a hydroxyl group represented by the following general formula (3), or a method of adding (meth)acrylic acid to a glycidyl group represented by the following general formula (5) is more preferred.

In the case of adding a (meth)acrylate having an isocyanate group to a hydroxyl group represented by the following general formula (3), it is preferable to add a (meth)acrylate having an isocyanate group in an amount of from 0.01 equivalents to 0.9 equivalents relative to 1 equivalent of the hydroxyl group. Similarly, in the case of adding (meth)acrylic acid to a glycidyl group represented by the following general formula (5), it is preferable to add (meth)acrylic acid in an amount of from 0.01 equivalents to 0.9 equivalents relative to 1 equivalent of the glycidyl group.

When these methods are used, a structure in which (meth)acryloyl groups of side chains are bonded to the main chain via a urethane bond or an ester bond, is formed. When the polymer has such a structure, it is preferable from the viewpoint of level difference embeddability.

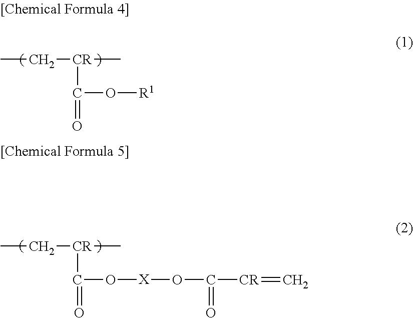

wherein R is a hydrogen atom or a methyl group; R¹ is an alkyl group having 4 to 18 carbon atoms; X is —CH₂CH₂—, —(CH₂CH₂O)ₚCH₂CH₂— (wherein p is an integer from 1 to 500), —R²—OCONH—R³—, or —R⁴—CH(OH)CH₂—; and R², R³ and R⁴ each independently are an alkylene group having 1 to 10 carbon atoms).

From the viewpoint of the surface flatness and the viewpoint that haze can be further decreased, R¹ preferably has 9 or more carbon atoms, and more preferably 12 or more carbon atoms. From the same points of view, an alkyl group having 18 or fewer carbon atoms is preferred. Here, the alkyl group may be a linear alkyl group, a branched alkyl group, or an alicyclic alkyl group, and the alkylene group may be a group formed by further eliminating one hydrogen atom from the alkyl group described above.

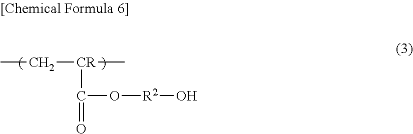

wherein R is a hydrogen atom or a methyl group; and R² is an alkylene group having 1 to 10 carbon atoms.

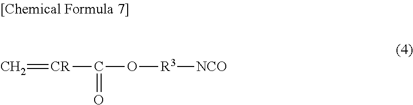

wherein R is a hydrogen atom or a methyl group; and R³ is an alkylene group having 1 to 10 carbon atoms.

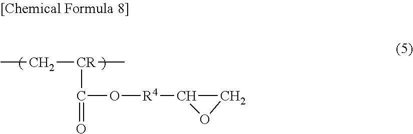

wherein R is a hydrogen atom or a methyl group; and R⁴ is an alkylene group having 1 to 10 carbon atoms.

Next, in the case of a side chain (meth)acryl-modified (meth)acrylate polymer as the component (C), the optimal content of the component (C) may vary with the rate of modification on the side chains. However, if the content is too high, the adhesive force is decreased, and it is likely to have a problem that peeling may occur, or air bubbles may easily enter. On the other hand, if the content is too low, the retention power becomes so low that reliability tends to decrease.

The component (C) is preferably 3.0×10² or more, and more preferably 5.0×10² or more, from the viewpoint that the occurrence of air bubbles and peeling under high temperature conditions or high temperature high humidity conditions can be further suppressed. From the same point of view, the weight average molecular weight of the same component is preferably 1.0×10⁵ or less.

Furthermore, the weight average molecular weight in the case of using a side chain (meth)acryl-modified (meth)acrylate polymer as the component (C) is preferably of the same extent as that of the component (A); however, since the side chains are modified, a compound having a slightly smaller weight average molecular weight can also be used. Specifically, the weight average molecular weight is preferably 1.0×10⁴ or more, more preferably 1.5×10⁴ or more, even more preferably 2.0×10⁴ or more, and particularly preferably 2.5×10⁴. Furthermore, the weight average molecular weight is preferably 3.0×10⁵ or less, more preferably 1.0×10⁵ or less, even more preferably 8.0×10⁴ or less, and particularly preferably 7.0×10⁴ or less.

The content of the component (C) is preferably 15% by mass or less relative to the total mass of the adhesive resin composition. When the content is 15% by mass or less, since the crosslinking density does not excessively increase, the adhesive resin composition acquires more sufficient adhesiveness, and an adhesive layer having high elasticity without brittleness can be obtained. Also, from the viewpoint that the level difference embeddability can be further enhanced, the content of the component (C) is more preferably 10% by mass or less, and even more preferably 7% by mass or less.

There are no particular limitations on the lower limit of the content of the component (C); however, from the viewpoint of making the film-forming properties more satisfactory, the content is preferably 0.1% by mass or more, more preferably 1% by mass or more, and even more preferably 2% by mass or more.

[Component (D): (D) Photopolymerization Initiator]

The component (D) is a component which accelerates a curing reaction by irradiation of active energy radiation. Here, the active energy radiation refers to, for example, ultraviolet radiation, electron beam, α-radiation, β-radiation, or γ-radiation.

The component (D) is not particularly limited, and any known materials such as benzophenone-based compounds, anthraquinone-based compounds, benzoyl-based compounds, sulfonium salts, diazonium salts, and onium salts can be used.

Specific examples include aromatic ketone compounds such as benzophenone, N,N,N′,N-tetramethyl-4,4′-diaminobenzophenone (Michler's ketone), N,N,N,N′-tetraethyl-4,4′-diaminobenzophenone, 4-methoxy-4′-dimethylaminobenzophenone, α-hydroxyisobutylphenone, 2-ethylanthraquinone, t-butylanthraquinone, 1,4-dimethylanthraquinone, 1-chloroanthraquinone, 2,3-dichloroanthraquinone, 3-chloro-2-methylanthraquinone, 1,2-benzoanthraquinone, 2-phenylanthraquinone, 1,4-naphthoquinone, 9,10-phenanthraquinone, thioxanthone, 2-chlorothioxanthone, 1-hydroxycyclohexyl phenyl ketone, 2,2-dimethoxy-1,2-diphenylethan-1-one, 2-hydroxy-2-methyl-1-phenylpropan-1-one, and 2,2-diethoxyacetophenone; benzoin compounds such as benzoin, methylbenzoin, and ethylbenzoin; benzoin ether compounds such as benzoin methyl ether, benzoin ethyl ether, benzoin isobutyl ether, and benzoin phenyl ether; benzil compounds such as benzil and benzil dimethyl ketal; ester compounds such as β-(acridin-9-yl)(meth)acrylic acid; acridine compounds such as 9-phenylacridine, 9-pyridylacridine, and 1,7-diacridinoheptane; 2,4,5-triarylimidazole dimers such as 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-diphenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)-5-phenylimidazole dimer, 2-(2,4-dimethoxyphenyl)-4,5-diphenylimidazole dimer, and 2-(p-methylmercaptophenyl)-4,5-diphenylimidazole dimer; 2-benzyl-2-dimethylamino-1-(4-morpholinophenyl)-1-butanone; 2-methyl-1-[4-(methylthio)phenyl]-2-morpholino-1-propane; bis(2,4,6-trimethylbenzoyl)phenylphosphine oxide; and oligo(2-hydroxy-2-methyl-1-(4-(1-methylvinyl)phenyl)propanone). These compounds may be used in combination of plural kinds.

Particularly, from the viewpoint of decreasing the haze value, α-hydroxyalkylphenone-based compounds such as 1-hydroxycyclohexyl phenyl ketone, 2-hydroxy-2-methyl-1-phenylpropan-1-one, and 1-[4-(2-hydroxyethoxy)phenyl]-2-hydroxy-2-methyl-1-propan-1-one; acylphosphine oxide-based compounds such as bis(2,4,6-trimethylbenzoyl)-phenylphosphine oxide, bis(2,6-dimethoxybenzoyl)-2,4,4-trimethyl-pentylphosphine oxide, and 2,4,6-trimethylbenzoyl-diphenylphosphine oxide; and oligo(2-hydroxy-2-methyl-1-(4-(1-methylvinyl)phenyl)propanone) are preferred.

Furthermore, in order to produce a particularly thick sheet (adhesive layer), it is preferable that the component (D) comprises acylphosphine oxide-based compounds such as bis(2,4,6-trimethylbenzoyl)-phenylphosphine oxide, bis(2,6-dimethoxybenzoyl)-2,4,4-trimethyl-pentylphosphine oxide, and 2,4,6-trimethylbenzoyl-diphenylphosphine oxide.

The content of the component (D) according to the present embodiment is preferably 0.05% by mass or more, and more preferably 0.1% by mass or more, relative to the total mass of the adhesive resin composition, from the viewpoint of practical use. Furthermore, the content of the component (D) is preferably 5% by mass or less, more preferably 3% by mass or less, and even more preferably 0.5% by mass or less. When the content of the component (D) is adjusted to 5% by mass or less, an adhesive layer which has high light transmissivity, does not undergo yellowing, and has superior level difference embeddability can be obtained.

[Other Additives]

The adhesive resin composition may comprise various additives as necessary, in addition to the components (A), (B), (C) and (D) described above. Examples of the various additives that can be incorporated include a polymerization inhibitor such as p-methoxyphenol, which is added for the purpose of increasing the storage stability of the adhesive resin composition; an oxidation inhibitor such as triphenyl phosphite, which is added for the purpose of increasing the heat resistance of the adhesive layer obtainable by photocuring the adhesive resin composition; a photostabilizer such as HALS (Hindered Amine Light Stabilizer), which is added for the purpose of increasing the resistance of the adhesive resin composition to light such as ultraviolet radiation; and a silane coupling agent that is added for the purpose of increasing the adhesiveness of the adhesive resin composition to glass or the like.

Meanwhile, when an adhesive sheet for an image display device is obtained, the adhesive layer is configured to be sandwiched between a substrate of a polymer film such as a polyethylene terephthalate film (heavy-to-release separator 3) and a cover film of the same material (light-to-release separator 4). At this time, in order to control the detachability between the adhesive layer and the substrate such as a polyethylene terephthalate film and the cover film, surfactants such as polydimethylsiloxane-based surfactants and fluorine-based surfactants can be incorporated into the adhesive resin composition.

These additives may be used singly, or plural additives may be used in combination. Meanwhile, the contents of these other additives are usually small amounts compared with the total of the contents of the components (A), (B), (C) and (D) described above, and the contents are generally about 0.01% by mass to 5% by mass relative to the total mass of the adhesive resin composition. Furthermore, the light transmittance of the adhesive layer to light in the visible light region (wavelength: 380 to 780 nm) is preferably 80% or higher, more preferably 90% or higher, and even more preferably 95% or higher.

The heavy-to-release separator 3 is preferably, for example, a polymer film of polyethylene terephthalate, polypropylene, polyethylene, or polyester, and among others, the heavy-to-release separator 3 is more preferably a polyethylene terephthalate film (hereinafter, may be referred to as “PET film”). The thickness of the heavy-to-release separator 3 is preferably 50 μm or more, more preferably 60 μm or more, and even more preferably 70 μm or more, from the viewpoint of workability. From the same point of view, the thickness of the heavy-to-release separator 3 is preferably 2.0×10² μm or less, more preferably 1.5×10² μm or less, and even more preferably 1.3×10² μm or less. It is preferable that the planar shape of the heavy-to-release separator 3 is larger than the planar shape of the adhesive layer 2, and that the outer edges of the heavy-to-release separator 3 are protruding outward relative to the outer edges of the adhesive layer 2. The width of the outer edges of the heavy-to-release separator 3 protruding out from the outer edges of the adhesive layer 2 is preferably 2 mm or more, and more preferably 4 mm or more, from the viewpoint of easy handleability, easy detachability, and reduced adhesion of dust. From the same point of view, the width of the outer edges of the heavy-to-release separator 3 protruding out from the outer edges of the adhesive layer 2 is preferably 20 mm or less, and more preferably 10 mm or less. In a case in which the planar shapes of the adhesive layer 2 and the heavy-to-release separator 3 are approximately quadrate shapes such as an approximately rectangular shape, the width of the outer edges of the heavy-to-release separator 3 protruding out from the outer edges of the adhesive layer 2 is preferably 2 mm or more on at least one edge, more preferably 4 mm or more on at least one edge, even more preferably 2 mm or more on every edge, and particularly preferably 4 mm or more on every edge, from the viewpoint described above. From the same point of view, the width is preferably 20 mm or less on at least one edge, more preferably 10 mm or less on at least one edge, even more preferably 20 mm or less on every edge, and particularly preferably 10 mm or less on every edge.

The light-to-release separator 4 is preferably, for example, a polymer film of polyethylene terephthalate, polypropylene, polyethylene or polyester, and among others, the light-to-release separator 4 is more preferably a polyethylene terephthalate film. The thickness of the light-to-release separator 4 is preferably 25 μm or more, more preferably 30 μm or more, and even more preferably 40 μm or more, from the viewpoint of workability. From the same point of view, the thickness of the light-to-release separator 4 is preferably 1.5×10² μm or less, more preferably 1.0×10² μm or less, and even more preferably 75 μm or less. It is preferable that the planar shape of the light-to-release separator 4 is larger than the planar shape of the adhesive layer 2, and that the outer edges of the light-to-release separator 4 are protruding outward relative to the outer edges of the adhesive layer 2. The width of the outer edges of the light-to-release separator 4 protruding out from the outer edges of the adhesive layer 2 is preferably 2 mm or more, and more preferably 4 mm or more, from the viewpoint of easy handleability, easy detachability, and reduced adhesion of dust. From the same point of view, the width of the outer edges of the light-to-release separator 4 protruding out from the outer edges of the adhesive layer 2 is preferably 20 mm or less, and more preferably 10 mm or less. In a case in which the planar shapes of the adhesive layer 2 and the light-to-release separator 4 are approximately quadrate shapes such as an approximately rectangular shape, the width of the outer edges of the light-to-release separator 4 protruding out from the outer edges of the adhesive layer 2 is preferably 2 mm or more on at least one edge, more preferably 4 mm or more on at least one edge, even more preferably 2 mm or more on every edge, and particularly preferably 4 mm or more on every edge, from the viewpoint described above. From the same point of view, the width is preferably 20 mm or less on at least one edge, more preferably 10 mm or less on at least one edge, even more preferably 20 mm or less on every edge, and particularly preferably 10 mm or less on every edge.

It is preferable that the peeling strength between the light-to-release separator 4 and the adhesive layer 2 is lower than the peeling strength between the heavy-to-release separator 3 and the adhesive layer 2. Thereby, it is more difficult for the heavy-to-release separator 3 to be detached from the adhesive layer 2 than the light-to-release separator 4. Furthermore, as will be described below, since a blade B passes through the adhesive layer 2 toward the edge of the heavy-to-release separator 3, the outer edge portion of the adhesive layer 2 is pressed against the heavy-to-release separator 3. Thereby, it is more difficult for the heavy-to-release separator 3 to be detached from the adhesive layer 2 than the light-to-release separator 4, and thus the light-to-release separator 4 can be detached before the detachment of the heavy-to-release separator 3 occurs. Therefore, the separators 3 and 4 can be detached one at a time, and the operation of detaching the separators 3 and 4 and attaching the adhesive layer 2 to a different adherend can be securely carried out one at a time. Meanwhile, the peeling strength between the heavy-to-release separator 3 and the adhesive layer 2 and the peeling strength between the light-to-release separator 4 and the adhesive layer 2 can be adjusted by, for example, subjecting the heavy-to-release separator 3 and the light-to-release separator 4 to a surface treatment. Regarding the surface treatment method, for example, a mold release treatment using a silicone-based compound or a fluorine-based compound may be used.

<Method for Producing Adhesive Sheet for Image Display Device I>

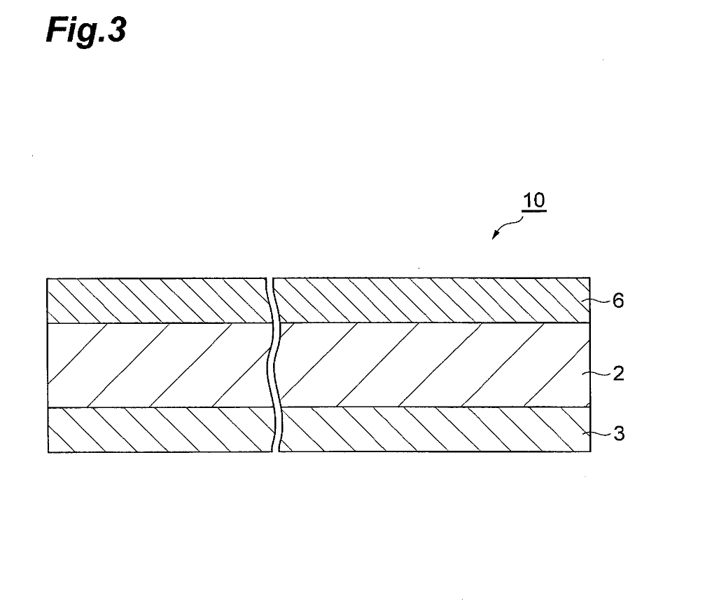

The adhesive sheet 1 (three-layered product) described above is produced as follows. First, as illustrated in FIG. 3, a base material film 10 in which an adhesive layer 2 is formed on a heavy-to-release separator 3, and a tentative separator 6 is formed on the adhesive layer 2, is prepared. The tentative separator 6 is, for example, a layer formed from the same material as that of the light-to-release separator 4.

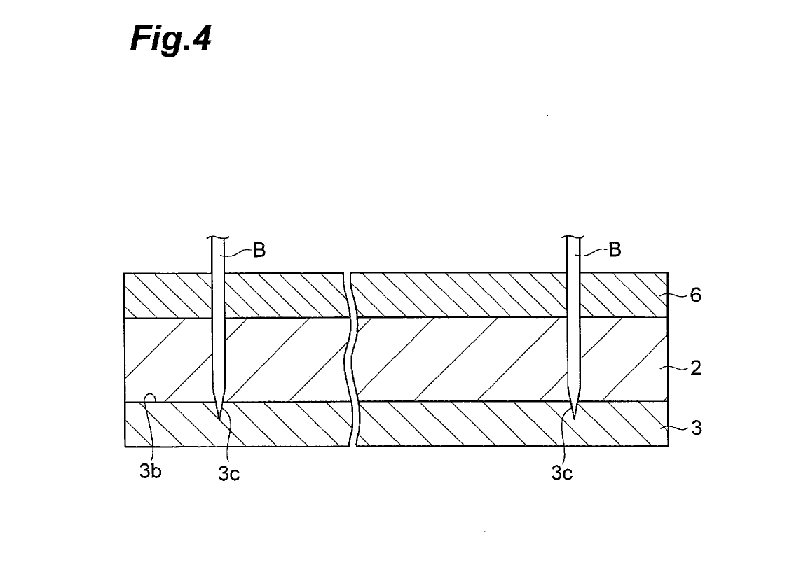

Subsequently, as illustrated in FIG. 4, the tentative separator 6 and the adhesive layer 2 are cut into a desired shaped using a punching apparatus equipped with a blade B (not illustrated in the diagram). The punching apparatus may be a crank type punch apparatus, may be a reciprocal type punching apparatus, or may be a rotary type punching apparatus. Furthermore, a laser cutter can also be used for the cutting. From the viewpoint of the detachability of various substrates, a rotary type punching apparatus is preferred. In this process, it is preferable to pass the blade B through the tentative separator 6 and the adhesive layer 2 to a depth that reaches the heavy-to-release separator 3, and cut the tentative separator 6 and the adhesive layer 2. Thereby, an incision area 3c is formed in the heavy-to-release separator 3, and this facilitates the detachment of the heavy-to-release separator 3 from the adhesive layer 2.

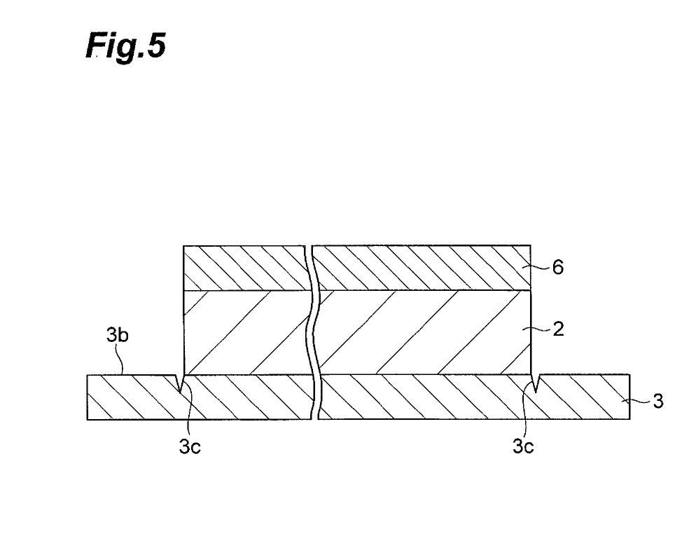

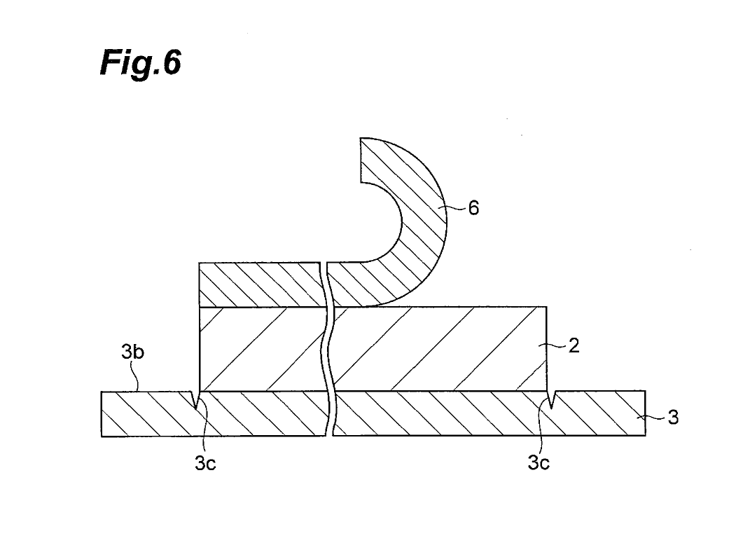

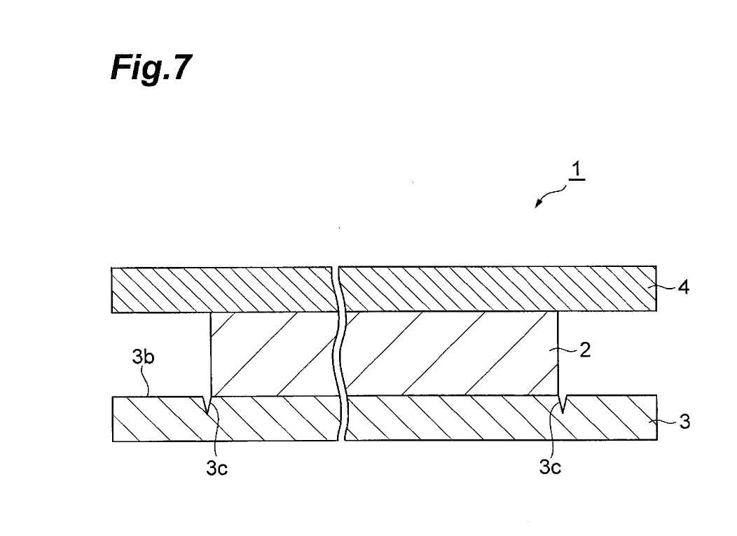

Subsequently, the external portions of the tentative separator 6 and the adhesive layer 2 are removed as illustrated in FIG. 5, the tentative separator 6 is detached from the adhesive layer 2 as illustrated in FIG. 6, and the light-to-release separator 4 is attached to the adhesive layer 2 as illustrated in FIG. 7. Through this process, an adhesive sheet 1 (three-layered product) is completed.

<Image Display Device>

Next, an image display device produced using the adhesive sheet 1 is described. The adhesive layer 2 of the adhesive sheet 1 can be applied to various image display devices. Examples of the image display device include a plasma display panel (PDP), a liquid crystal display (LCD), a cathode ray tube (CRT), a field emission display (FED), an organic EL display (OELD), a 3D display, and an electronic paper (EP). The adhesive layer 2 of the present embodiment can also be used to combine and bond functional layers having functionality, such as an anti-reflection layer, an anti-fouling layer, a pigment layer, and a hard coat layer of an image display device, and a transparent protective plate.

The anti-reflection layer may be any layer having anti-reflection properties with a visible light reflectance of 5% or less, and a layer obtained by treating a transparent substrate such as a transparent plastic film by an existing anti-reflection method can be used.

The anti-fouling layer is intended to make it difficult for the surface to be stained, and an existing layer formed of a fluorine-based resin or a silicone-based resin in order to decrease the surface tension, can be used.

The pigment layer is used in order to increase the color purity, and is used in order to reduce any unnecessary light in a case in which the color purity of the light emitted by the image display unit of, for example, a liquid crystal display unit is low. The pigment layer can be obtained by dissolving a pigment that absorbs light of unnecessary parts in a resin, and forming a film or laminating on a substrate film such as a polyethylene film or a polyester film.

The hard coat layer is used in order to obtain high surface hardness. Regarding the hard coat layer, for example, a layer obtained by film-making or laminating an acrylic resin such as urethane acrylate or epoxy acrylate; or an epoxy resin on a substrate film such as a polyethylene film, can be used. In order to increase the surface hardness as such, a layer obtained by film-making or laminating a hard coat layer on a transparent protective plate made of glass, an acrylic resin or a polycarbonate, can also be used.

The adhesive layer 2 can be used in a state of being laminated on a polarizing plate. In this case, the adhesive layer 2 may be laminated on the visible surface side of the polarizing plate, or may be laminated on the opposite side.

In the case of using the adhesive layer on the visible surface side of a polarizing plate, an anti-reflection layer, an anti-fouling layer and a hard coat layer can be further laminated on the visible surface side of the adhesive layer 2, and in the case of using the adhesive layer between a polarizing plate and a liquid crystal cell, a layer having functionality can be laminated on the visible surface side of the polarizing plate.

In the case of producing such a laminate, the adhesive layer 2 can be laminated using a roll laminator, a vacuum bonding machine, or a sheet bonding machine.

It is preferable that the adhesive layer 2 is disposed at an appropriate position on the visible side, which is a position between an image display unit and a transparent protective plate of the forefront surface on the visible side in an image display device. Specifically, it is preferable that the adhesive layer 2 is applied (used) between the image display unit and the transparent protective plate.

Furthermore, in an image display device having a touch panel combined with an image display unit, it is preferable that the adhesive layer 2 of the present embodiment is applied (used) between the touch panel and the image display unit, and/or between the touch panel and the transparent protective plate; however, in view of the configuration of the image display device, the position of the adhesive layer 2 is not intended to be limited to the positions described above as long as the adhesive layer 2 of the present embodiment can be applied.

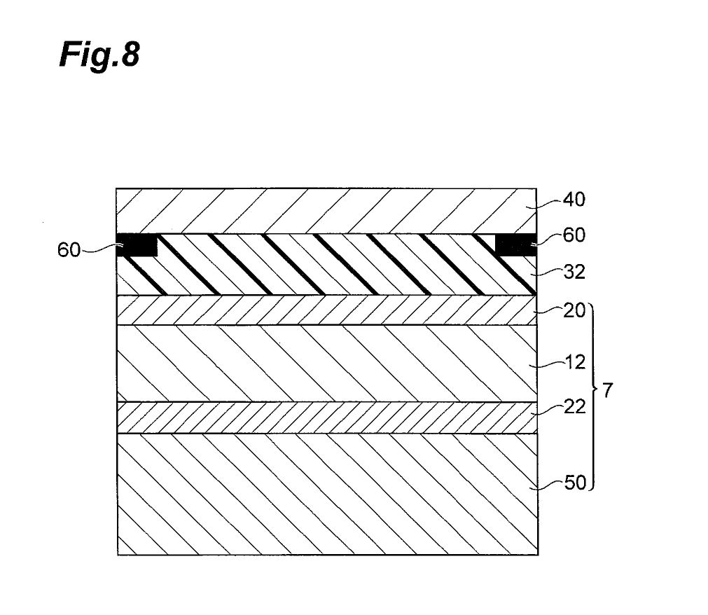

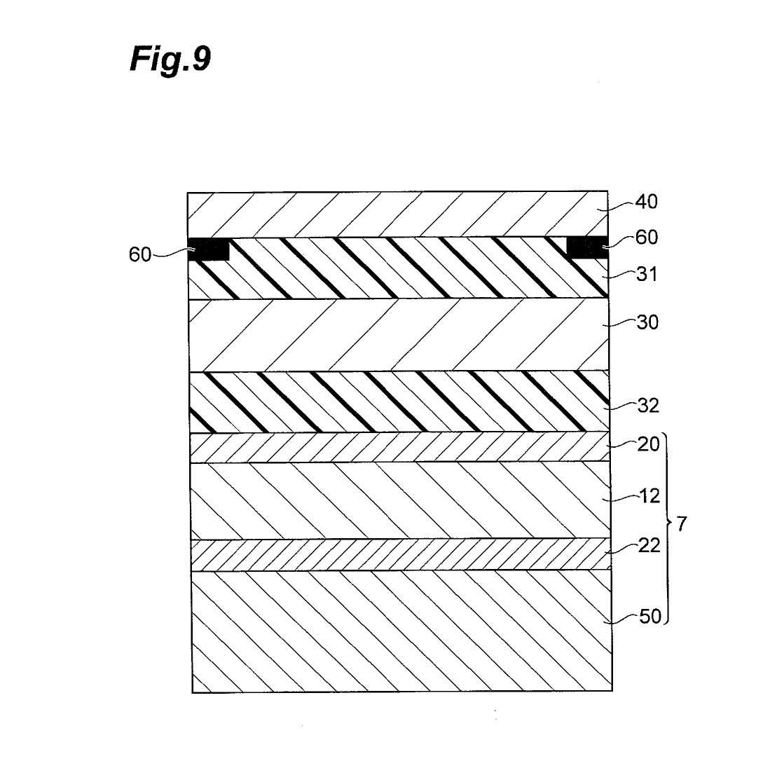

Hereinafter, a liquid crystal display device, which is one of image display devices, will be described in detail as an example, with reference to FIG. 8 and FIG. 9.

FIG. 8 is a cross-sectional view of a lateral side schematically illustrating an embodiment of the liquid crystal display device of the present invention. The liquid crystal display device illustrated in FIG. 8 is configured to comprise an image display unit 7 in which a backlight system 50, a polarizing plate 22, a liquid crystal display cell 12, and a polarizing plate 20 are laminated in this order; a transparent resin layer 32 provided on top of the polarizing plate 20 that serves as the visible side of the liquid crystal display device; and a transparent protective plate (protective panel) 40 provided on the surface of the transparent resin layer 32. A level difference 60 provided on the surface of the transparent protective plate 40 is embedded by the transparent resin layer 32. Meanwhile, the transparent resin layer 32 basically corresponds to the adhesive layer of the present embodiment. The thickness of the level difference 60 may vary with, for example, the size of the liquid crystal display device; however, in a case in which the thickness is 40 μm to 1.0×10² μm, it is particularly effective to use the adhesive layer of the present embodiment.

FIG. 9 is a cross-sectional view of a lateral side schematically illustrating a liquid crystal display device equipped with a touch panel, which is an embodiment of the liquid crystal display device of the present invention. The liquid crystal display device illustrated in FIG. 9 is configured to comprise an image display unit 7 in which a backlight system 50, a polarizing plate 22, a liquid crystal display cell 12 and a polarizing plate 20 are laminated in this order; a transparent resin layer 32 provided on top of the polarizing plate 20 that serves as the visible side of the liquid crystal display device; a touch panel 30 provided on top of the transparent resin layer 32; a transparent resin layer 31 provided on top of the touch panel 30; and a transparent protective plate 40 provided on the front surface of the transparent resin layer 31. A level difference 60 provided on the surface of the transparent protective plate 40 is embedded by the transparent resin layer 31. Meanwhile, the transparent resin layer 31 and the transparent resin layer 32 basically correspond to the adhesive layer of the present embodiment.

Meanwhile, in the liquid crystal display device of FIG. 9, a transparent resin layer is interposed both between the image display unit 7 and the touch panel 30, and between the touch panel 30 and the transparent protective plate 40 having the level difference 60. However, it is acceptable if the transparent resin layer is disposed in at least one of these sites, and particularly in the case of using the adhesive layer 2 of the present embodiment, it is preferable that the adhesive layer is interposed between the touch panel 30 and the transparent protective plate 40 having the level difference 60. Furthermore, in a case in which the touch panel is an on-cell type, the touch panel and the liquid crystal display cell are integrated. A specific example thereof is that the liquid crystal display cell 12 of the liquid crystal display device of FIG. 8 is replaced with an on-cell type.

Furthermore, in recent years, development of a liquid crystal display cell incorporated with a touch panel function, which is called an in-cell type touch panel, is in progress. A liquid crystal display device equipped with such a liquid crystal display cell is configured to comprise a transparent protective plate, a polarizing plate, and a liquid crystal display cell (liquid crystal display cell with touch panel function), and the adhesive layer 2 of the present embodiment of the present invention can be suitably used also in a liquid crystal display device employing such an in-cell type touch panel.

According to the liquid crystal display devices illustrated in FIG. 8 and FIG. 9, since the liquid crystal display devices comprise the adhesive layer of the present embodiment as the transparent resin layer 31 or 32, the liquid crystal display devices have impact resistance, and clear images with high contrast but without double reflection are obtained.

Regarding the liquid crystal display cell 12, a cell formed from a liquid crystal material well known in the relevant technical field can be used. Furthermore, liquid crystal display cells are classified into, for example, a TN (Twisted Nematic) system, a STN (Super-Twisted Nematic) system, a VA (Vertical Alignment) system, and an IPS (In-Place-Switching) system according to the method of controlling the liquid crystal material; however, in the present invention, any liquid crystal display cell using any control method may be used.

Regarding the polarizing plates 20 and 22, a polarizing plate that is commonly used in the relevant technical field can be used. The surface of such a polarizing plate may have been subjected to an anti-reflection treatment, an anti-fouling treatment, or a hard coating treatment. Such a surface treatment may be carried out on one surface of the polarizing plate, or on both surfaces of the polarizing plate.

Regarding the touch panel 30, there are available, for example, a resistant film system in which the electrodes are brought into contact by the pressure applied by a finger or an object touching the surface; an electrostatic capacitive system in which the change in the electrostatic capacity occurring when a finger or an object touches the surface is detected; and an electromagnetic induction system. However, the adhesive layer 2 of the present invention is particularly suitable to be used in a liquid crystal display device which employs an electrostatic capacitive type touch panel. Regarding the touch panel 30, any touch panel that is commonly used in the relevant technical field can be used; however, an example of the electrostatic capacitive type touch panel is a touch panel having a structure in which a transparent electrode is formed on a substrate. Examples of the substrate include a glass substrate, a polyethylene terephthalate film, and a cycloolefin polymer film. Furthermore, an example of the transparent electrode may be a metal oxide such as ITO (Indium Tin Oxide). The thickness of the substrate is about 20 μm to 1.0×10³ μm. The thickness of the transparent electrode is about 10 nm to 5.0×10² nm.

The transparent resin layer 31 or 32 can be formed to a thickness of, for example, about 0.02 mm to 3 mm. Particularly, in regard to the adhesive layer 2 of the present embodiment, a superior effect can be manifested by making the adhesive layer into a thick film, and thus, the adhesive layer can be suitably used in a case in which a transparent resin layer 31 or 32 having a thickness of from 1.0×10² μm to 5.0×10² μm is formed.

Regarding the transparent protective plate 40, a general optical transparent substrate can be used. Specific examples thereof include plates of inorganic materials such as a glass substrate and a quartz plate; plastic substrates such as an acrylic resin substrate, a polycarbonate plate, and a cycloolefin polymer plate; and resin sheets such as a thick polyester sheet. In a case in which high surface hardness is required, a glass substrate and an acrylic resin substrate are preferred, and a glass substrate is more preferred. The surface of such a transparent protective plate may have been subjected to, for example, an anti-reflection treatment, an anti-fouling treatment, or a hard coating treatment. Such a surface treatment may be carried out on one surface of the transparent protective plate, or may be carried out on both surfaces. The transparent protective plate is such that plural sheets of transparent protective plates may be used in combination.

The backlight system 50 is configured to typically comprise a reflecting means such as a reflecting plate; and a lighting means such as a lamp.

<Method for Manufacturing Image Display Device I>

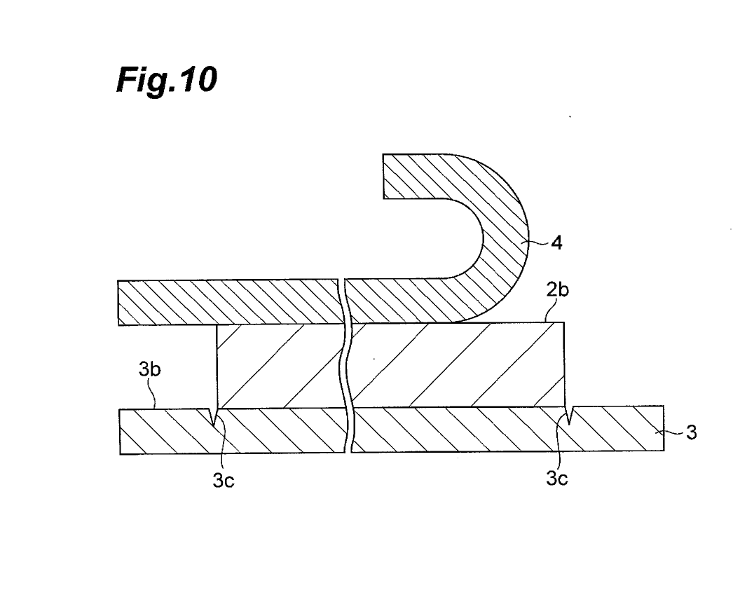

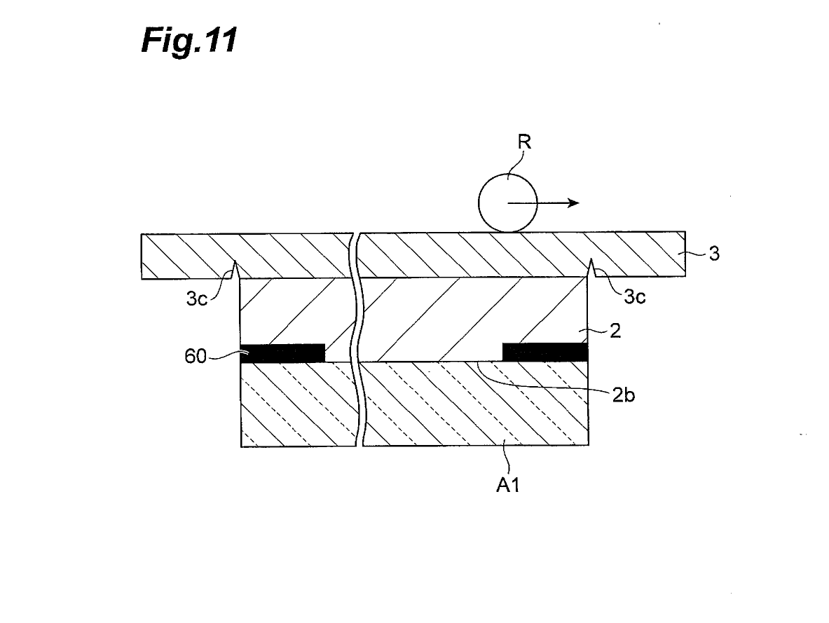

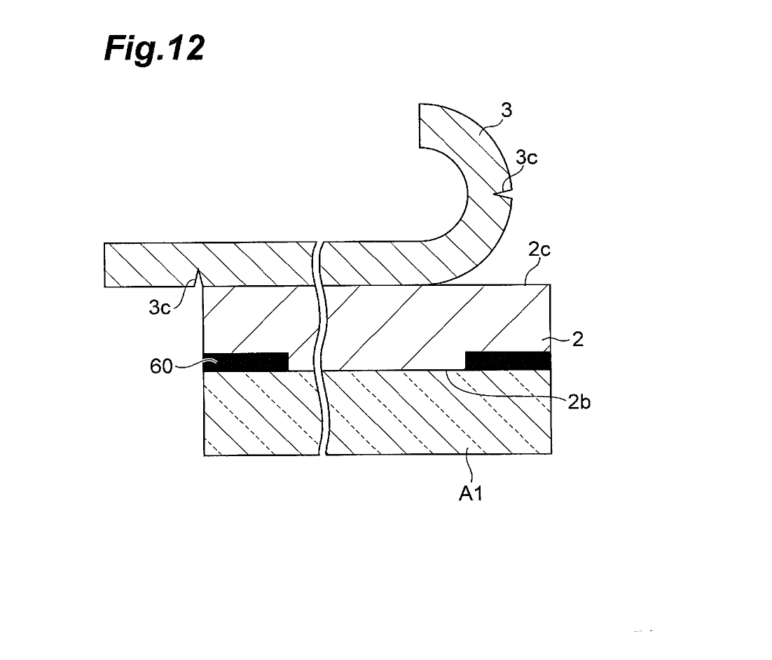

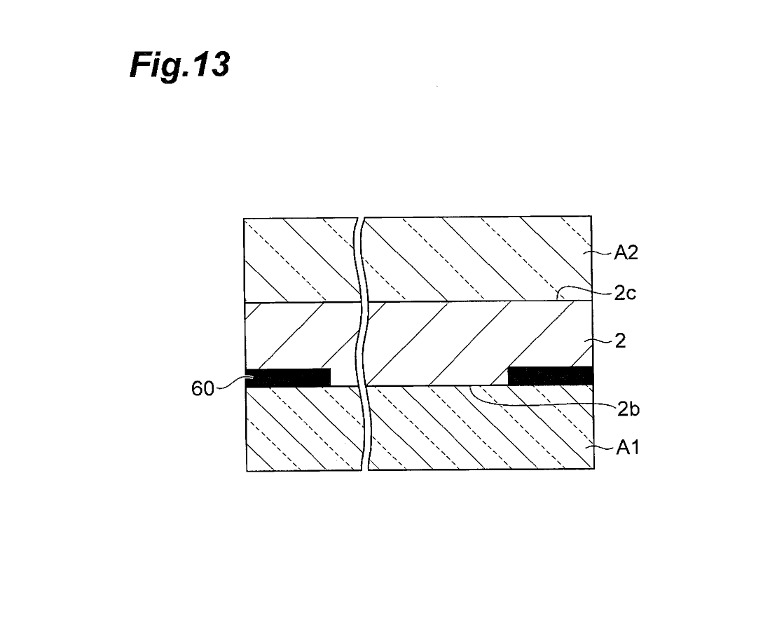

The adhesive sheet 1 (three-layered product) is used as follows in, for example, the assembly of an image display device. First, as illustrated in FIG. 10, the light-to-release separator 4 is detached from the adhesive sheet 1 (three-layered product), and thereby, an adhesive surface 2b of the adhesive layer 2 is exposed. Subsequently, as illustrated in FIG. 11, the adhesive surface 2b of the adhesive layer 2 is adhered to an adherend A1 and pressed with, for example, a roller R. At this time, a level difference 60 provided on the surface of the adherend A1 is embedded by the adhesive layer 2. The adherend A1 is, for example, an image display unit, a transparent protective plate, or a touch panel. Subsequently, as illustrated in FIG. 12, the heavy-to-release separator 3 is detached from the adhesive layer 2, and an adhesive surface 2c of the adhesive layer 2 is exposed. Subsequently, as illustrated in FIG. 13, the adhesive surface 2c of the adhesive layer 2 is adhered to an adherend A2, and the assembly is subjected to a heating and pressuring treatment (autoclave treatment). The adherend A2 is, for example, an image display unit, a transparent protective plate, or a touch panel. In this mariner, the adherends can be bonded together via the adhesive layer 2. Meanwhile, the heating and pressurization treatment conditions at this time are such that the temperature is from 40° C. to 80° C., and the pressure is from 0.3 MPa to 0.8 MPa. However, in a case in which the level difference of the adherend surface is 30 μm to 1.0×10² μm, it is preferable that the temperature is from 50° C. to 70° C., and the pressure is from 0.4 MPa to 0.7 MPa, from the viewpoint that more air bubbles in the vicinity of the level difference can be eliminated. Furthermore, from the viewpoint described above, the treatment time is preferably 5 minutes or longer, and more preferably 10 minutes or longer. From the same point of view, the treatment time is preferably 60 minutes or shorter, and more preferably 50 minutes or shorter.

Furthermore, it is preferable that the manufacturing method described above comprises a process of irradiating the adhesive layer 2, before or after the autoclave treatment, with ultraviolet radiation through any one side of the two adherends (for example, a transparent protective plate or a touch panel). Thereby, reliability (reduction of the generation of air bubbles and suppression of peeling) under high temperature and high humidity conditions and the adhesive force can be further enhanced. From the viewpoint of further enhancing the reliability under high temperature and high humidity conditions, it is preferable to irradiate ultraviolet radiation through the side of an adherend that does not have a level difference (for example, a touch panel).

The amount of irradiation of ultraviolet radiation is not particularly limited; however, the amount of irradiation is preferably about 5.0×10² mJ/cm² to 5.0×10³ mJ/cm². Meanwhile, it is preferable to carry out the process of irradiating ultraviolet radiation after the autoclave treatment, from the viewpoint of enhancing reliability under high temperature and high humidity conditions. In regard to a structure obtained in this manner, when a glass substrate (soda lime glass) or an acrylic resin substrate is employed as an adherend, the peeling strength between the adhesive layer 2 and such a substrate is preferably 5 N/10 mm or more, more preferably 8 N/10 mm or more, and even more preferably 10 N/10 mm or more, from the viewpoint of suppressing detachment of the adhesive layer in the image display device. From the viewpoint of practical use, the peeling strength between the adhesive layer 2 and the substrate is preferably 30 N/10 mm or less. Meanwhile, the peeling strength can be measured by 180°-peel (3 seconds at a peeling speed of 300 mm/min, measurement temperature: 25° C.) using a tensile testing machine (“TENSILON RTC-1210” manufactured by Orientec Co., Ltd.).

By the process described above, the adhesive layer 2 is disposed between the adherend A1 and the adherend A2. It is particularly preferable that the adhesive layer 2 is used in a state of being disposed between the transparent protective plate and the touch panel, or between the touch panel and the image display unit.

The liquid crystal display device of FIG. 8 described above can be manufactured by obtaining a laminate by interposing the adhesive layer 2 of the present embodiment between the image display unit 7 and the transparent protective plate 40. That is, in the image display device described in FIG. 8, the adhesive layer 2 of the present embodiment can be laminated on top of the polarizing plate 20 by a lamination method.

The liquid crystal display device of FIG. 9 described above can be manufactured by obtaining a laminate by interposing the adhesive layer 2 of the present embodiment between the image display unit and the touch panel, or between the touch panel and the transparent protective plate.

### Second Embodiment

<Adhesive Sheet for Image Display Device

The adhesive sheet 1 for an image display device (four-layered product) of the present embodiment comprises a film-like adhesive layer; a first and second substrate layers laminated so as to interpose the adhesive layer therebetween; and a carrier layer further laminated on the second substrate layer, and the outer edges of the first substrate layer and the carrier layer are protruding outward relative to the outer edges of the adhesive layer.

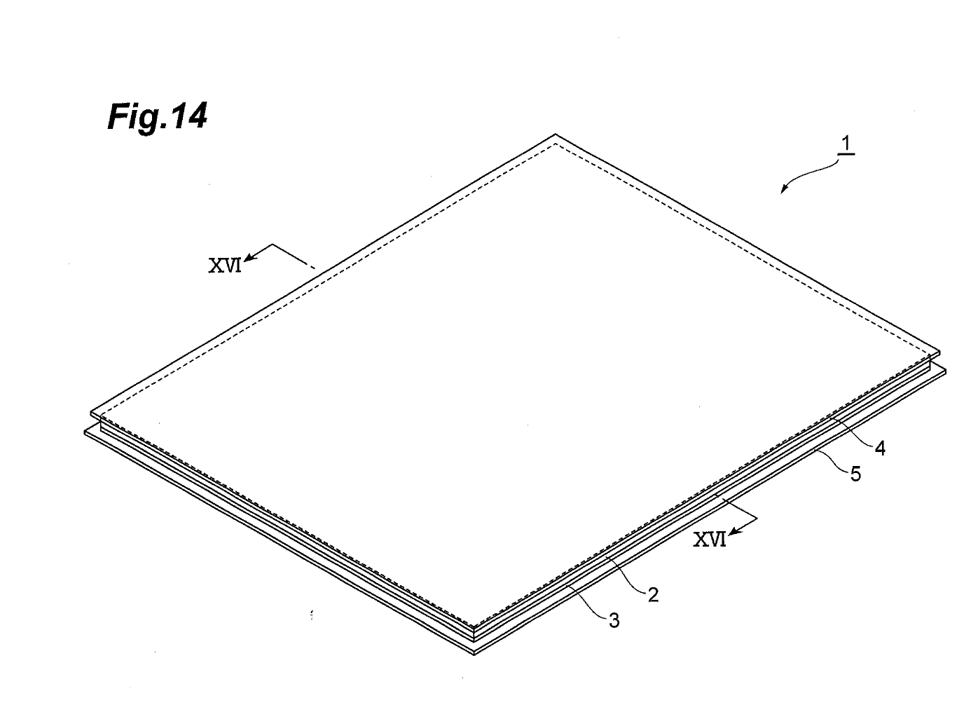

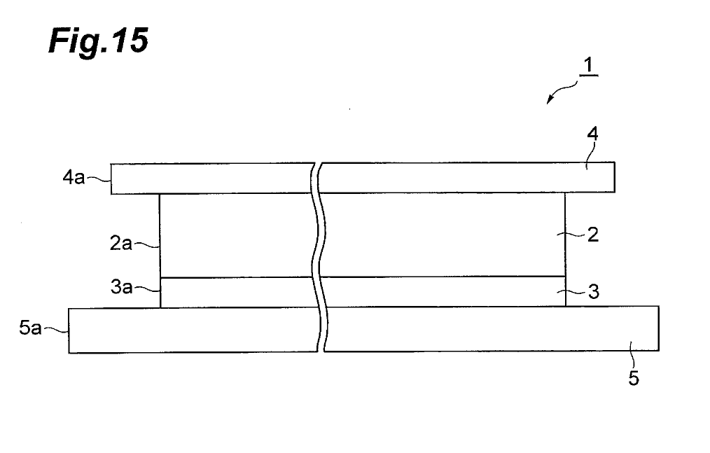

That is, as illustrated in FIG. 14 and FIG. 15, the adhesive sheet 1 (four-layered product) related to the present embodiment comprises a transparent film-like adhesive layer 2; a light-to-release separator 4 (first substrate layer) and a heavy-to-release separator 3 (second substrate layer) laminated so as to interpose the adhesive layer 2; and a carrier film 5 (carrier layer) further laminated on the heavy-to-release separator 3.

The outer edges 5a of the carrier film 5 are protruding outward relative to the outer edges 2a of the adhesive layer 2. Thereby, the carrier film 5 can be easily detached from the second substrate layer by picking up the outer edge portions of the carrier film 5 that are protruding outward. Furthermore, it is preferable that the outer edges 5a of the carrier film 5 are protruding outward relative to the outer edges 4a of the light-to-release separator 4. Thereby, since the outer edge portions of the carrier film 5 are configured to be more easily picked up, the carrier film 5 can be more easily detached. The width of the outer edges 5a of the carrier film 5 protruding out from the outer edges 4a of the light-to-release separator 4 is preferably 0.5 mm or more, and more preferably 1 mm or more, from the viewpoints of easy handleability, easy detachability, and reduced adhesion of dust. From the same point of view, the width of the outer edges 5a of the carrier film 5 protruding out from the outer edges 4a of the light-to-release separator 4 is preferably 10 mm or less, and more preferably 5 mm or less. In a case in which the planar shapes of the carrier film 5, the adhesive layer 2, the heavy-to-release separator 3 and the light-to-release separator 4 are approximately quadrate shapes such as an approximately rectangular shape, the width of the outer edges 5a of the carrier film 5 protruding out from the outer edges 4a of the light-to-release separator 4 is preferably 0.5 mm or more on at least one edge, more preferably 1 mm or more on at least one edge, even more preferably 0.5 mm or more on every edge, and particularly preferably 1 mm or more on every edge, from the viewpoint described above. From the same point of view, the width of the outer edges 5a of the carrier film 5 protruding out from the outer edges 4a of the light-to-release separator 4 is preferably 10 mm or less on at least one edge, more preferably 5 mm or less on at least one edge, even more preferably 10 mm or less on every edge, and particularly preferably 5 mm or less on every edge.

Since the heavy-to-release separator 3 is protected by the carrier film 5 up to the immediately preceding process, scratches on the surface of the heavy-to-release separator 3 are reduced. Thereby, scratches on the adhesive layer 2 can be easily recognized, and an adhesive layer 2 having scratches thereon can be easily excluded before being adhered to an adherend.

The carrier film 5 is, for example, a polymer film of polyethylene terephthalate, polypropylene, polyethylene or polyester, and among others, the carrier film 5 is preferably a polyethylene terephthalate film. The thickness of the carrier film 5 is preferably 15 μm or more, and more preferably 20 μm or more, from the viewpoint of workability. From the same point of view, the thickness of the carrier film 5 is preferably 100 μm or less, more preferably 80 μm or less, and even more preferably 50 μm or less.

The peeling strength between the light-to-release separator 4 and the adhesive layer 2 is lower than the peeling strength between the heavy-to-release separator 3 and the adhesive layer 2. The peeling strength between the carrier film 5 and the heavy-to-release separator 3 is lower than the peeling strength between the heavy-to-release separator 3 and the adhesive layer 2. Here, the peeling strength between the carrier film 5 and the heavy-to-release separator 3 is more preferably lower than the peeling strength between the light-to-release separator 4 and the adhesive layer 2; however, even if the peeling strength is higher, the effects of the present invention are not impaired.

The peeling strength between the carrier film 5 and the heavy-to-release separator 3 is adjusted by, for example, the kind of the adhesive layer formed between the carrier film 5 and the heavy-to-release separator 3, and the thickness of the adhesive. The kind of the adhesive formed between the carrier film 5 and the heavy-to-release separator 3 may be, for example, an acrylic adhesive. The thickness of the adhesive layer formed between the carrier film 5 and the heavy-to-release separator 3 is preferably 0.1 μm or more. Furthermore, the thickness is preferably 10 μm or less, and more preferably 5 μm or less.

As such, when the adhesive sheet 1 (four-layered product) of the present embodiment is used, the respective separators 3 and 4, and the carrier film 5 can be reliably and easily detached in a predetermined order without peeling failure, while the adhesive layer 2 is protected.

<Method for Producing Adhesive Sheet for Image Display Device II>

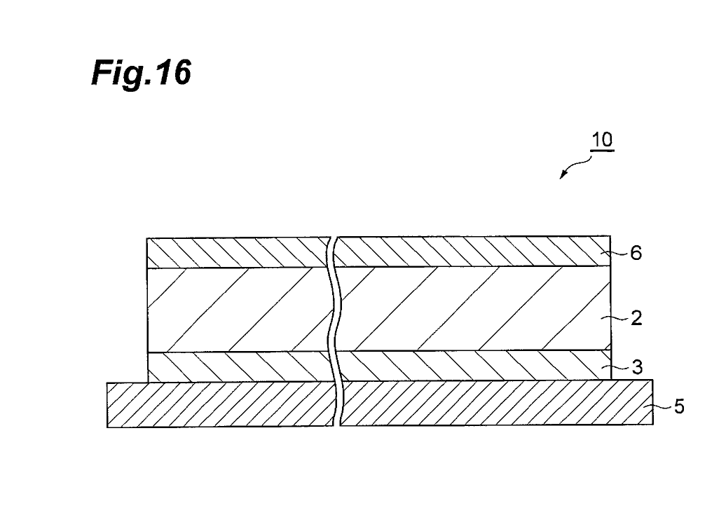

The adhesive sheet 1 (four-layered product) of the present embodiment is produced as follows. First, as illustrated in FIG. 16, a base material film 10 in which a heavy-to-release separator 3, an adhesive layer 2, and a tentative separator 6 are sequentially laminated on a carrier film 5, is prepared. The heavy-to-release separator 3 is adhered to the carrier film 5 via the adhesive layer described above. The tentative separator 6 is a layer formed from, for example, the same material as that of the light-to-release separator 4.

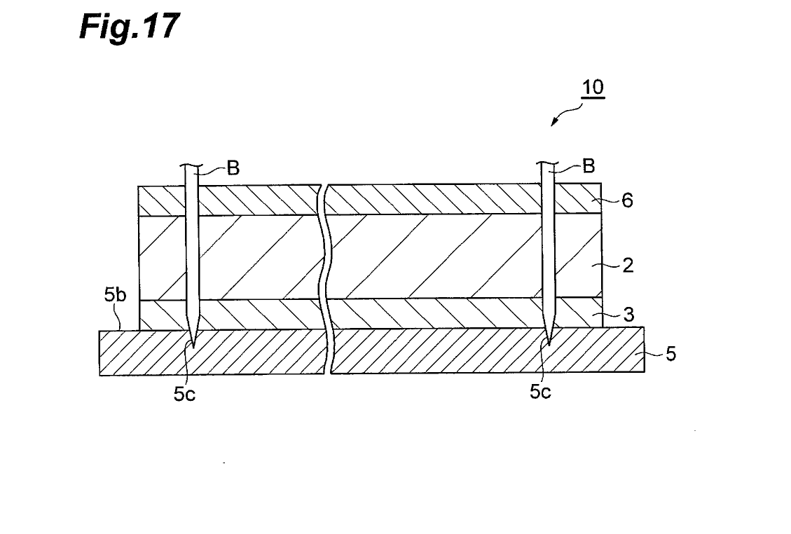

Subsequently, the tentative separator 6, the adhesive layer 2, and the heavy-to-release separator 3 are cut to a desired shape using a punching apparatus equipped with a blade B (not illustrated in the figures). In this process, as illustrated in FIG. 17, it is preferable that the blade B is passed through the tentative separator 6, the adhesive layer 2 and the heavy-to-release separator 3, to a depth that reaches the carrier film 5. Thereby, an incision area 5c is formed on the surface 5b on the adhesive layer 2 side of the carrier film 5. As such, the adhesive layer 2 and the heavy-to-release separator 3 can be completely cut by reaching the blade B from the tentative separator 6 to the carrier film 5.

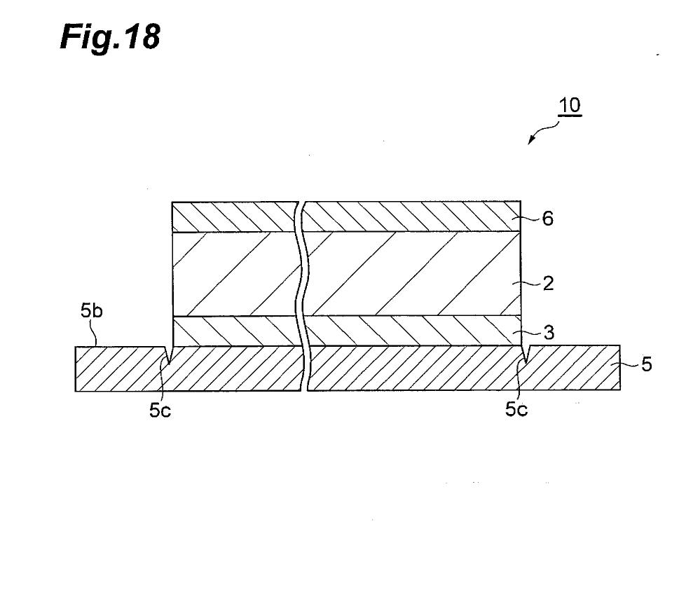

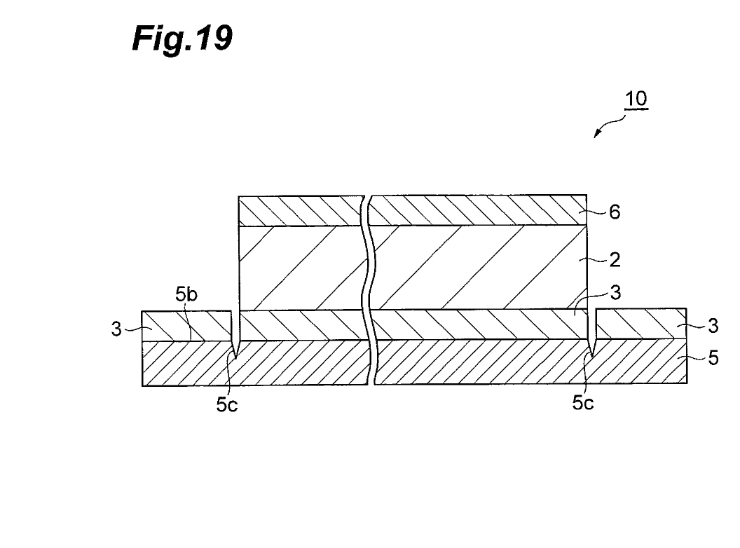

Subsequently, as illustrated in FIG. 18, the outer portions of the tentative separator 6, the adhesive layer 2 and the heavy-to-release separator 3 are removed. At this time, it is preferable that as illustrated in FIG. 19, the outer edges of the heavy-to-release separator 3 are approximately in the same plane as the outer edges of the carrier film 5, so that the outer edges of the carrier film 5 would not protrude outward relative to the outer edges of the heavy-to-release separator 3. That is, it is preferable that only the outer portions of the tentative separator 6 and the adhesive layer 2 are removed, and the outer portion of the heavy-to-release separator 3 is not removed but is left on the carrier film 5, so that the heavy-to-release separator 3 after cutting is in a state of being still attached to the carrier film 5. Thereby, the problem that the carrier film 5 having its surface exposed adheres to another area, can be effectively prevented.

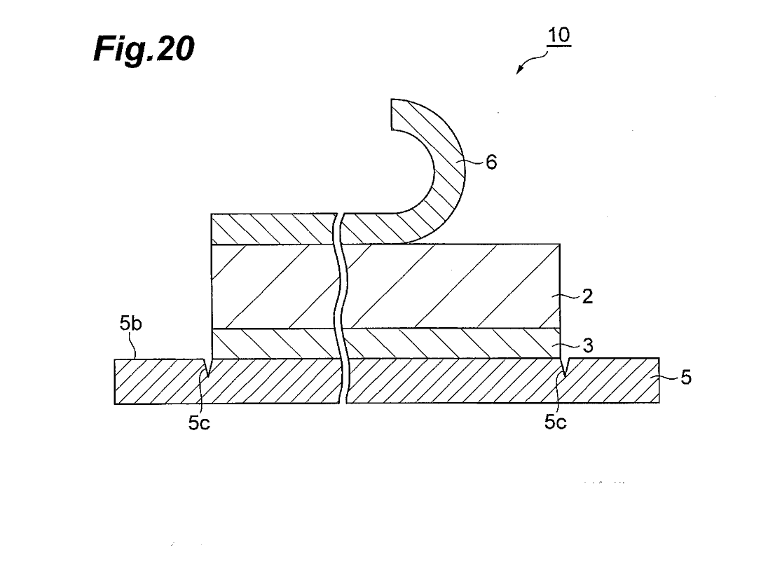

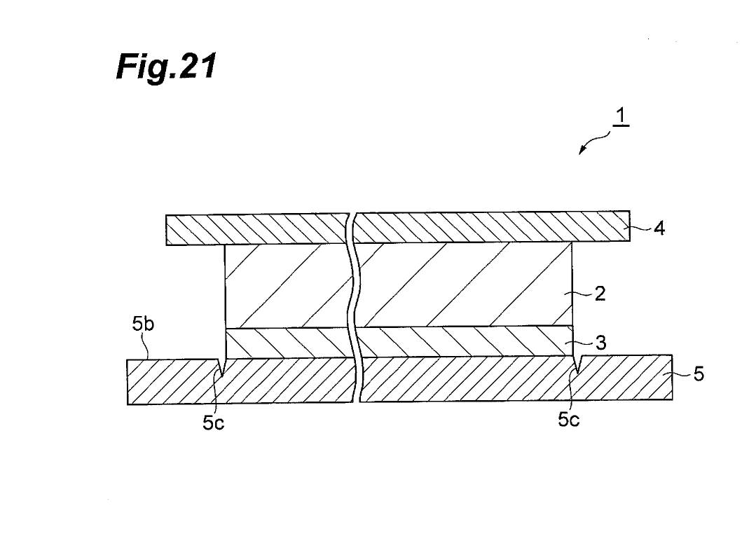

After the outer portions of the tentative separator 6, the adhesive layer 2, and the heavy-to-release separator 3 are removed as illustrated in FIG. 18, subsequently the tentative separator 6 is detached from the adhesive layer 2 as illustrated in FIG. 20, and the light-to-release separator 4 is attached to the adhesive layer 2 as illustrated in FIG. 21. Through the above process, the adhesive sheet 1 (four-layered product) of the present embodiment is completed. As such, with a film that has been cut such that the outer edges of the heavy-to-release separator 3 are approximately in the same plane as the outer edges of the adhesive layer 2, since the difference in the ease of detachment between the light-to-release separator 4 and the heavy-to-release separator 3 becomes more significant, the light-to-release separator 4 can be more easily detached before the heavy-to-release separator 3 is detached. Furthermore, since the positions of the outer edges of the adhesive layer 2 become clear as the outer edges and the heavy-to-release separator 3 and the outer edges of the adhesive layer 2 are matched, alignment of the adhesive layer 2 and an adherend is made easier.

<Method for Manufacturing Image Display Device II>

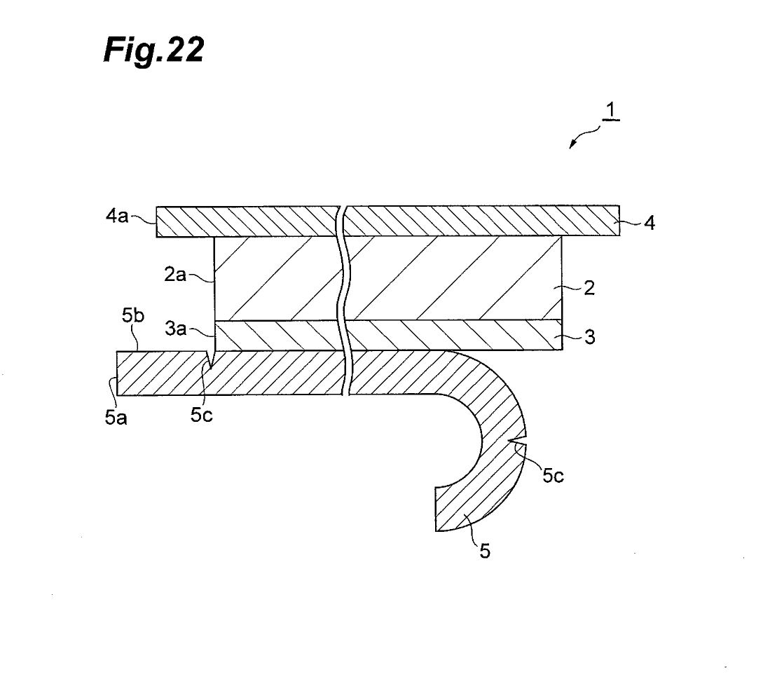

The adhesive sheet 1 (four-layered product) of the present embodiment can be used in the same manner as in the case of the adhesive sheet of the first embodiment, except that first, as illustrated in FIG. 22, the carrier film 5 is detached from the heavy-to-release separator 3, and then the adhesive sheet is used.

Thus, suitable embodiments of the present invention have been described, but the present invention is not necessarily intended to be limited to the above-described embodiments, and various modifications can be made to the extent that the outline of the invention is maintained.

### EXAMPLES

Hereinafter, the present invention will be described in more detail by way of Examples. In these Examples, adhesive sheets related to the first embodiment and the second embodiment are produced, but the present invention is not intended to be limited to these Examples.

### Synthesis Example 1

### Synthesis of Acrylic Acid Derivative Polymer (A-1)

In a reactor vessel equipped with a cooling tube, a thermometer, a stirring apparatus, a dropping funnel and a nitrogen inlet tube, 96.0 g of isostearyl acrylate (manufactured by Osaka Organic Chemical Industry, Ltd., trade name: “ISTA”) and 24.0 g of 2-hydroxyethyl acrylate (manufactured by Osaka Organic Chemical Industry, Ltd., trade name “HEA”) as initial monomers, and 150.0 g of methyl ethyl ketone were introduced, and while the reactor vessel was purged with nitrogen at a blow rate of 100 mL/min, the monomers were heated from normal temperature (25° C.) to 80° C. for 15 minutes. Thereafter, while the temperature was maintained at 80° C., a solution produced by using 24.0 g of isostearyl acrylate and 6.0 g of 2-hydroxyethyl acrylate as additional monomers and dissolving 5.0 g of t-butyl peroxy-2-ethylhexanoate in these monomers was prepared, and the resulting solution was added dropwise over 120 minutes. After completion of the dropwise addition, the mixture was further allowed to react for 2 hours.

Subsequently, methyl ethyl ketone was distilled off, and thereby a copolymer of isostearyl acrylate and 2-hydroxyethyl acrylate (weight average molecular weight 3.0×10⁴) was obtained.

### Synthesis Example 2

### Synthesis of Acrylic Acid Derivative Polymer (A-2)

In a reactor vessel equipped with a cooling tube, a thermometer, a stirring apparatus, a dropping funnel and a nitrogen inlet tube, 108.0 g of isostearyl acrylate and 12.0 g of 2-hydroxyethyl acrylate as initial monomers, and 150.0 g of methyl ethyl ketone were introduced, and while the reactor vessel was purged with nitrogen at a blow rate of 100 mL/min, the monomers were heated from normal temperature (25° C.) to 80° C. for 15 minutes. Thereafter, while the temperature was maintained at 80° C., a solution produced by using 27.0 g of isostearyl acrylate and 3.0 g of 2-hydroxyethyl acrylate as additional monomers and dissolving 5.0 g of t-butyl peroxy-2-ethylhexanoate in these monomers was prepared, and this solution was added dropwise over 120 minutes. After completion of the dropwise addition, the mixture was further allowed to react for 2 hours.

Subsequently, methyl ethyl ketone was distilled off, and thereby a copolymer of isostearyl acrylate and 2-hydroxyethyl acrylate (weight average molecular weight 3.0×10⁴) was obtained.

### Synthesis Example 3

### Synthesis of Acrylic Acid Derivative Polymer (A-3)

In a reactor vessel equipped with a cooling tube, a thermometer, a stirring apparatus, a dropping funnel and a nitrogen inlet tube, 96.0 g of 2-ethylhexyl acrylate and 24.0 g of 2-hydroxyethyl acrylate as initial monomers, and 150.0 g of methyl ethyl ketone were introduced, and while the reactor vessel was purged with nitrogen at a blow rate of 100 mL/min, the monomers were heated from normal temperature (25° C.) to 80° C. for 15 minutes. Thereafter, while the temperature was maintained at 80° C., a solution produced by using 24.0 g of 2-ethylhexyl acrylate and 6.0 g of 2-hydroxyethyl acrylate as additional monomers and dissolving 5.0 g of t-butyl peroxy-2-ethylhexanoate in these monomers was prepared, and this solution was added dropwise over 120 minutes. After completion of the dropwise addition, the mixture was further allowed to react for 2 hours.

Subsequently, methyl ethyl ketone was distilled off, and thereby a copolymer of 2-ethylhexyl acrylate and 2-hydroxyethyl acrylate (weight average molecular weight 3.0×10⁴) was obtained.

### Synthesis Example 4

### Synthesis of Side Chain Methacryl-Modified Acrylate Polymer (C-1)

In a reactor vessel equipped with a cooling tube, a thermometer, a stirring apparatus, a dropping funnel and an oxygen inlet tube, 100.0 g of the acrylic acid derivative polymer (A-1) of Synthesis Example 1, 2.0 g of 2-isocyanatoethyl methacrylate, 0.05 g of p-methoxyphenol as a polymerization inhibitor, and 0.03 g of dibutyltin dilaurate as a catalyst were introduced, and while air was blown in at a blow rate of 100 mL/min, the mixture was heated from normal temperature (25° C.) to 75° C. for 15 minutes. Thereafter, while the temperature was maintained at 75° C., the mixture was allowed to react for 2 hours, and then an IR analysis was performed. As a result, loss of isocyanate groups was confirmed. At this time point, the reaction was completed, and thus a side chain methacryl-modified acrylate polymer having polymerizable unsaturated bonds (weight average molecular weight 3.0×10⁴) was obtained.

For the IR analysis, a Fourier transform infrared spectrophotometer (FT-710) manufactured by Horiba, Ltd. was used.

### Synthesis Example 5

### Synthesis of Side Chain Methacryl-Modified Acrylate Polymer (C-2)

In a reactor vessel equipped with a cooling tube, a thermometer, a stirring apparatus, a dropping funnel and an air inlet tube, 100.0 g of the acrylic acid derivative polymer (A-2) of Synthesis Example 2, 2.0 g of 2-isocyanatoethyl methacrylate, 0.05 g of p-methoxyphenol as a polymerization inhibitor, and 0.03 g of dibutyltin dilaurate as a catalyst were introduced, and while air was blown in at a blow rate of 100 mL/min, the mixture was heated from normal temperature (25° C.) to 75° C. for 15 minutes. Thereafter, while the temperature was maintained at 75° C., the mixture was allowed to react for 2 hours, and then an IR analysis was performed. As a result, loss of isocyanate groups was confirmed. At this time point, the reaction was completed, and thus a side chain methacryl-modified acrylate polymer having polymerizable unsaturated bonds (weight average molecular weight 3.0×10⁴) was obtained.

### Synthesis Example 6

### Synthesis of Side Chain Methacryl-Modified Acrylate Polymer (C-3)

In a reactor vessel equipped with a cooling tube, a thermometer, a stirring apparatus, a dropping funnel and an air inlet tube, 100.0 g of the acrylic acid derivative polymer (A-3) of Synthesis Example 3, 2.0 g of 2-isocyanatoethyl methacrylate, 0.05 g of p-methoxyphenol as a polymerization inhibitor, and 0.03 g of dibutyltin dilaurate as a catalyst were introduced, and while air was blown in at a blow rate of 100 mL/min, the mixture was heated from normal temperature (25° C.) to 75° C. for 15 minutes. Thereafter, while the temperature was maintained at 75° C., the mixture was allowed to react for 2 hours, and then an IR analysis was performed. As a result, loss of isocyanate groups was confirmed. At this time point, the reaction was completed, and thus a side chain methacryl-modified acrylate polymer having polymerizable unsaturated bonds (weight average molecular weight 3.0×10⁴) was obtained.

### Synthesis Example 7

### Synthesis of Side Chain Methacryl-Modified Acrylate Polymer (C-4)

In a reactor vessel equipped with a cooling tube, a thermometer, a stirring apparatus, a dropping funnel and a nitrogen inlet tube, 96.0 g of lauryl acrylate (alkyl acrylate having an alkyl group with 12 carbon atoms) and 24.0 g of 2-hydroxyethyl acrylate as initial monomers, and 150.0 g of methyl ethyl ketone were introduced, and while the reactor vessel was purged with nitrogen at a blow rate of 100 mL/min, the monomers were heated from normal temperature (25° C.) to 80° C. for 15 minutes. Thereafter, while the temperature was maintained at 80° C., a solution produced by using 24.0 g of lauryl acrylate and 6.0 g of 2-hydroxyethyl acrylate as additional monomers and dissolving 5.0 g of t-butyl peroxy-2-ethylhexanoate in these monomers was prepared, and this solution was added dropwise over 120 minutes. After completion of the dropwise addition, the mixture was further allowed to react for 2 hours.

Subsequently, methyl ethyl ketone was distilled off, and thereby a copolymer of lauryl acrylate and 2-hydroxyethyl acrylate (weight average molecular weight 3.0×10⁴) was obtained.

Next, in a reactor vessel equipped with a cooling tube, a thermometer, a stirring apparatus, a dropping funnel and an air inlet tube, the copolymer thus obtained, 2.0 g of 2-isocyanatoethyl methacrylate, 0.05 g of p-methoxyphenol as a polymerization inhibitor, and 0.03 g of dibutyltin dilaurate as a catalyst were introduced, and while air was blown in at a blow rate of 100 mL/min, the mixture was heated from normal temperature (25° C.) to 75° C. for 15 minutes. Thereafter, while the temperature was maintained at 75° C., the mixture was allowed to react for 2 hours, and then an IR analysis was performed. As a result, loss of isocyanate groups was confirmed. At this time point, the reaction was completed, and thus a side chain methacryl-modified acrylate polymer having polymerizable unsaturated bonds (weight average molecular weight 3.0×10⁴) was obtained.

### Synthesis Example 8

### Synthesis of Polyurethane Diacrylate (C-5)

In a reactor vessel equipped with a cooling tube, a thermometer, a stirring apparatus, a dropping funnel and an air inlet tube, 285.3 g of polypropylene glycol (number average molecular weight 2.0×10³), 24.5 g of an unsaturated fatty acid hydroxyalkyl ester-modified ε-caprolactone (manufactured by Daicel Corp., trade name: “PLACCEL FA2D”), 0.13 g of p-methoxyphenol as a polymerization inhibitor, and 0.5 g of dibutyltin dilaurate as a catalyst were introduced, and while air was blown in at a blow rate of 100 mL/min, the mixture was heated from normal temperature (25° C.) to 75° C. for 15 minutes. Thereafter, while the temperature was maintained at 75° C., 39.6 g of isophorone diisocyanate was uniformly added dropwise thereto over 2 hours, and a reaction was carried out.

After completion of the dropwise addition, the reaction mixture was allowed to react for 6 hours. It was confirmed by an IR analysis that isocyanate groups were lost, and the reaction was completed. Thus, a polyurethane acrylate having polypropylene glycol and isophorone diisocyanate as structural units and having (meth)acryloyl groups at both chain ends (weight average molecular weight 3.0×10⁴) was obtained.

Meanwhile, the weight average molecular weight is a value determined by analyzing using gel permeation chromatography using tetrahydrofuran (THF) as a solvent, and calculating relatively using a calibration curve of polystyrene standards and using the apparatus and analysis conditions described below. On the occasion of producing the calibration curve, five sample sets of polystyrene standards (PStQuick MP-H, PStQuick B [manufactured by Tosoh Corp., trade names]) were used.

Apparatus: High performance GPC apparatus HLC-8320 GPC (detector: differential refractometer) (manufactured by Tosoh Corp., trade name)

Solvent used: Tetrahydrofuran (THF)

Column: Column TSKGEL SuperMultipore HZ-H (manufactured by Tosoh Corp., trade name)

Column size: Column length 15 cm, column inner diameter 4.6 mm

Measurement temperature: 40° C.

Flow rate: 0.35 mL/minute

Sample concentration: 10 mg/THF 5 mL

Injection amount: 20 μL

The following various components that were used as raw materials of adhesive resin compositions were prepared.

Component A: Acrylic acid-based derivative polymers (A-1) to (A-3)

Component B: Isostearyl acrylate (manufactured by Osaka Organic Chemical Industry, Ltd., trade name: “ISTA”)
: n-stearyl acrylate (manufactured by Osaka Organic Chemical Industry, Ltd., trade name: “STA”)
: 2-ethylhexyl acrylate (2EHA)
: 4-hydroxybutyl acrylate (4HBA)

Component C: Side chain methacryl-modified acrylate polymers (C-1) to (C-4)
: polyurethane diacrylate (C-5)
: 1,9-nonanediol diacrylate (C-6, manufactured by Kyoeisha Chemical Co., Ltd.)

Component D: 1-Hydroxycycohexyl phenyl ketone (I-184, manufactured by BASF Japan, Ltd., trade name “Irgacure-184”)

### Example 1

[Production of Adhesive Sheet 1 (Three-Layered Product)]

An adhesive sheet 1 was produced by the following steps (I) to (V), using a polyethylene terephthalate (manufactured by Fujimori Kogyo Co., Ltd.) having a thickness of 75 μm as a heavy-to-release separator 3, and a polyethylene terephthalate (manufactured by Fujimori Kogyo Co., Ltd.) having a thickness of 50 μm as a light-to-release separator 4 and a tentative separator 6.

(I) 60 g of the acrylic acid derivative polymer (A-1), 30.9 g of isostearyl acrylate (ISTA), 5.0 g of 4-hydroxybutyl acrylate (4HBA), 4.0 g of a side chain methacryl-modified acrylate polymer (C-1), and 0.1 g of 1-hydroxycyclohexyl phenyl ketone (I-184) were weighed, and these were mixed with stirring. Thus, an adhesive resin composition that was liquid at normal temperature was obtained.

(II) This adhesive resin composition was applied on the heavy-to-release separator 3 to form a coating film, and then a tentative separator 6 was laminated on the coating film Ultraviolet radiation was irradiated (4.0×10² mJ/cm²) using an ultraviolet irradiation apparatus (manufactured by Eye Graphics Co., Ltd.), and thus a laminate having an adhesive layer 2 interposed between the heavy-to-release separator 3 and the tentative separator 6 was obtained. The adhesive resin composition was applied by adjusting the thickness of the adhesive layer 2 to be 1.5×10² μm.

(III) The laminate was cut to a size of 220 mm×180 mm, using a rotary blade having a diameter of 72 mm.

(IV) The adhesive layer 2 and the tentative separator 6 in the cut laminate were cut to a size of 205 mm×160 mm using a rotary blade having a diameter of 72 mm. At this time, cutting was performed such that the two edges on the longer edge side of the heavy-to-release separator 3 would protrude out by 7.5 mm from the two edges on the longer edge side of the adhesive layer 2, and the two edges on the shorter edge side of the heavy-to-release separator 3 would protrude out by 10 mm from the two edges on the shorter edge side of the adhesive layer 2. Meanwhile, for the cutting in the steps (III) and (IV), a rotary type punching apparatus equipped with a rotary blade having a diameter of 72 mm was used.

(V) The tentative separator 6 was detached, and a light-to-release separator 4 having a size of 215 mm×170 mm was laminated on the adhesive layer 2. In this manner, an adhesive sheet 1 was obtained. At this time, lamination was performed such that the two edges on the longer edge side of the light-to-release separator 4 would protrude out by 5 mm from the two edges on the longer edge side of the adhesive layer 2, and the two edges on the shorter edge side of the light-to-release separator 4 would protrude out by 5 mm from the two edges on the shorter edge side of the adhesive layer 2.

### Examples 2 to 11 and Comparative Examples 1 to 4

Adhesive sheets 1 were obtained in the same manner as in Example 1, except that the mixing amounts and the amounts of exposure were set to the conditions indicated in Table 1. Meanwhile, in Table 1, the unit for the values indicating the mixing amounts is gram (g).

[Various Evaluations]

For the adhesive sheets obtained in the various Examples and Comparative Examples, the following evaluations of items (1) to (6) were carried out.

(1) Measurement of Glass Transition Temperature (Tg), Shear Storage Modulus, Loss Modulus, and tan δ

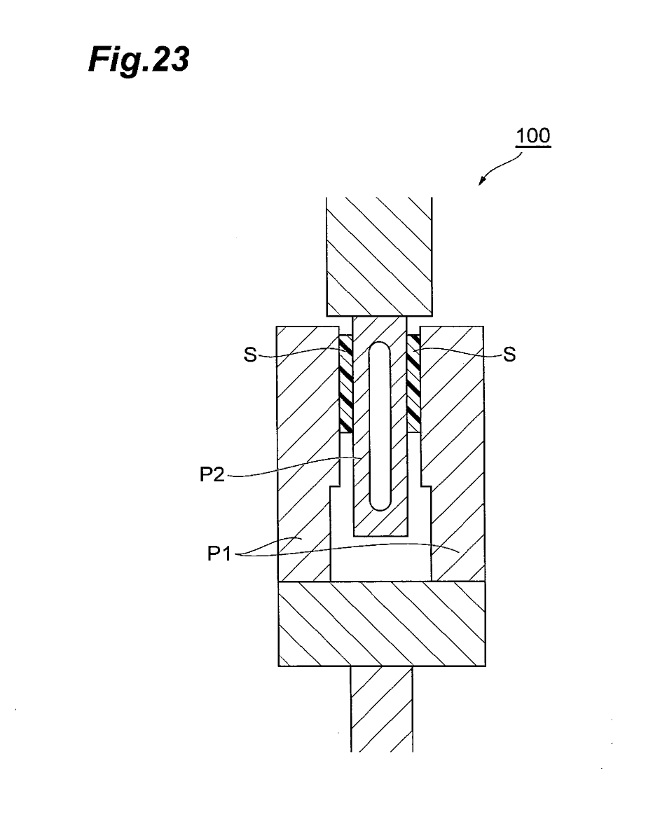

Three sheets of the adhesive layer obtained in the step (II) and having a thickness of 1.5×10² μm were overlapped to obtain a thickness of about 4.5×10² μm, and the adhesive layers were cut to a dimension of 10 mm in width and 10 mm in length. Thus, a sample was produced. Two pieces of this sample were prepared, and as illustrated in FIG. 23, a sample S was sandwiched between plates P1 at both ends and a plate P2 at the center using a jig 100 to be used as a measurement sample. Then, the glass transition temperature (Tg), shear storage modulus, loss modulus, and tan δ of the sample were measured using a wide range dynamic viscoelastic analyzer (manufactured by Rheometric Scientific Inc., trade name: “Solids Analyzer RSA-II”. The measurement conditions comprised “shear sandwich mode, frequency: 1.0 Hz, measurement temperature range: −20° C. to 100° C., and a rate of temperature increase: 5° C./min”.

(2) Level Difference Embeddability

The adhesive sheet thus produced was cut to a dimension of 50 mm in width and 80 mm in length, and the polyethylene terephthalate film on one surface of the adhesive sheet was detached. The adhesive sheet was pasted to a cycloolefin polymer film (manufactured by Zeon Corp., trade name: “ZEONOR FILM ZF16”) having a dimension of 56 mm×86 mm×0.1 mm (thickness), using a hand roller (25° C., load: 4.9 N (500 gf)). Next, the polyethylene terephthalate film on the other surface of the adhesive sheet where the cycloolefin polymer film was not pasted was detached, and then a glass substrate which had a dimension of 56 mm×86 mm×0.7 mm (thickness) and was provided on the outer periphery with a printed layer (level difference) having a dimension of 9 mm in width and 80 μm in thickness, was bonded thereon so as to interpose the adhesive layer therebetween, using a vacuum bonding apparatus (manufactured by Takatori Corp., trade name: “TPL-0512MH”) under the conditions of 60° C., 0.5 MPa, and a degree of vacuum of 50 Pa, for 60 seconds. Thereafter, an autoclave treatment (45° C., 0.5 MPa) was carried out for 10 minutes, and then ultraviolet radiation was irradiated at 2.0×10³ mJ/cm² through the cycloolefin polymer film surface side using an ultraviolet irradiation apparatus (manufactured by Eye Graphics Co., Ltd.). Thus, an evaluation sample was obtained.

An evaluation of the external appearance (air bubbles, detachment) of the peripheral part of the printed layer (level difference) was carried out using this evaluation sample and an optical microscope. Thus, the level difference embeddability was determined according to the following evaluation criteria.

(Evaluation Criteria)

A: Air bubbles and detachment are not observed.

B: Air bubbles or detachment is observed only on one edge.

C: Air bubbles or detachment is observed on two or more edges.

(3) Surface Flatness

The adhesive sheet thus produced was cut to a dimension of 50 mm in width and 80 mm in length, and the polyethylene terephthalate film on one surface of the adhesive sheet was detached. The adhesive sheet was pasted to a cycloolefin polymer film (manufactured by Zeon Corp., trade name: “ZEONOR FILM ZF16”) having a dimension of 56 mm×86 mm×0.1 mm (thickness), using a hand roller (25° C., load: 4.9 N (500 gf)). Next, the polyethylene terephthalate film on the other surface of the adhesive sheet where the cycloolefin polymer film was not pasted was detached, and then a glass substrate which had a dimension of 56 mm×86 mm×0.7 mm (thickness) and was provided on the outer periphery with a printed layer (level difference) having a dimension of 9 mm in width and 80 μm in thickness, was bonded thereon so as to interpose the adhesive layer therebetween, using a vacuum bonding apparatus under the conditions of 60° C., 0.5 MPa, and a degree of vacuum of 50 Pa, for 60 seconds. Thereafter, an autoclave treatment (45° C., 0.5 MPa) was carried out for 10 minutes, and then ultraviolet radiation was irradiated at 2.0×10³ mJ/cm² through the cycloolefin polymer film surface side using an ultraviolet irradiation apparatus. Thus, an evaluation sample was obtained.

Using this sample, the surface shape of the peripheral part of the printed layer (level difference) on the cycloolefin polymer film side was analyzed under the following conditions using a surface roughness analyzer (manufactured by Kosaka Laboratory, Ltd., trade name: “SE3500”).

Shape of tip made of diamond: Conical shape

Tip radius: 2 μm

Vertical angle: 60°

Rate of measurement: 0.15 mm/sec

Force of measurement: 0.75 mN

Cut-off value: 0.8 mm

Reference length: 0.8 mm

Evaluated length: 10 mm

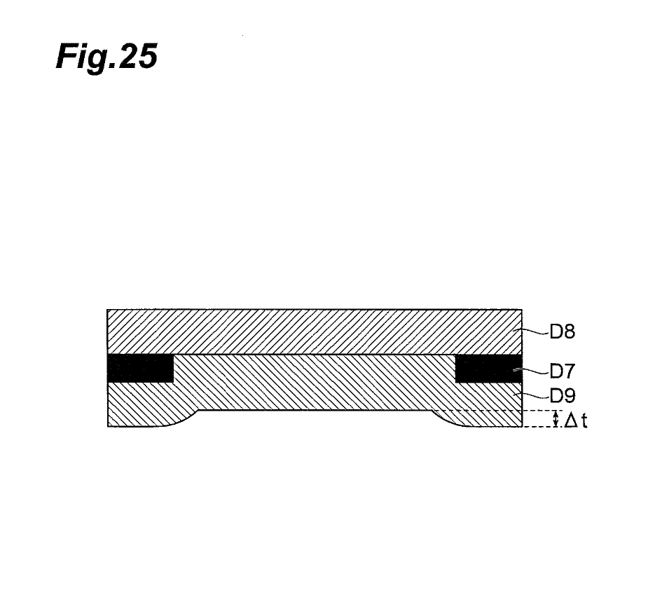

The measurement was carried out continuously for 5 mm of the printed layer surface and 5 mm of an unprinted surface, and the surface flatness was determined from the difference in the measured values between the printed layer surface and the unprinted surface (Δt in FIG. 25) according to the following evaluation criteria.

(Evaluation Criteria)

A: Less than 20 μm

B: 20 μm or more but less than 40 μm

C: 40 μm or more

(4) Bleeding Properties

The adhesive sheet thus produced was cut to a dimension of 50 mm in width and 80 mm in length, and the polyethylene terephthalate film on one surface of the adhesive sheet was detached. The adhesive sheet was pasted to a cycloolefin polymer film having a dimension of 56 mm×86 mm×0.1 mm (thickness), using a hand roller (25° C., load: 4.9 N (500 gf)), and then the diagonal length of the adhesive sheet part was measured. Next, the polyethylene terephthalate film on the other surface of the adhesive sheet where the cycloolefin polymer film was not pasted was detached, and then a glass substrate which had a dimension of 56 mm×86 mm×0.7 mm (thickness) and was provided on the outer periphery with a printed layer (level difference) having a dimension of 9 mm in width and 80 μm in thickness, was bonded thereon so as to interpose the adhesive material therebetween, using a vacuum bonding apparatus under the conditions of 60° C., 0.5 MPa, and a degree of vacuum of 50 Pa, for 60 seconds. The assembly was left to stand still for 30 minutes at 25° C., and then was used as an evaluation sample.

The diagonal length of the adhesive sheet portion of this evaluation sample was measured, and the bleeding properties were determined from the amount of change (amount of increase) in the diagonal length of the adhesive sheet portion before and after the bonding with the glass substrate, according to the following evaluation criteria.

(Evaluation Criteria)

A: Less than 1.5 mm

B: 1.5 mm or more but less than 3 mm

C: 3 mm or more

(5) Optical Characteristics

(A) Measurement of L*, a*, and b*

The adhesive sheet thus produced was cut to a dimension of 40 mm in width and 100 mm in length, and the polyethylene terephthalate film on one surface of the adhesive sheet was detached. The adhesive sheet was bonded to a glass substrate (soda lime glass) having a dimension of 50 mm×100 mm×3 mm (thickness), using a hand roller (25° C., load: 4.9 N (500 gf)). Next, the polyethylene terephthalate film on the opposite surface of the adhesive sheet was detached, and the measurement was performed so that the adhesive layer surface was positioned to the light source side in a spectrophotometer (manufactured by Nippon Denshoku Industries Co., Ltd., trade name: “SQ-2000”).

(B) Measurement of Turbidity (Haze)

The adhesive sheet thus produced was cut to a dimension of 40 mm in width and 100 mm in length, and the polyethylene terephthalate film on one surface of the adhesive sheet was detached. The adhesive sheet was bonded to a glass substrate (soda lime glass) having a dimension of 50 mm×100 mm×3 mm (thickness), using a hand roller (25° C., load: 4.9 N (500 gf)). Next, the polyethylene terephthalate film on the opposite surface of the adhesive sheet was detached, and turbidity was measured according to JIS K 7136 so that the adhesive layer surface was positioned to the light source side in a turbidimeter (manufactured by Nippon Denshoku Industries Co., Ltd., trade name: “NDH-5000”).

Haze (%)=(Td/Tt)×100

Td: Diffusion transmittance

Tt: Total light transmittance

(6) Measurement of Dielectric Constant

The adhesive sheet thus produced was irradiated with ultraviolet radiation at 2.0×10³ mJ/cm² using an ultraviolet irradiation apparatus, and then the adhesive sheet was cut to a dimension of 50 mm in width and 50 mm in length. The polyethylene terephthalate film on one surface of the adhesive sheet was detached, and the glossy surface side of a copper foil (manufactured by Nippon Denkai, Ltd., trade name: “SLP-18”) having a dimension of 100 mm×100 mm×18 μm (thickness) was pasted thereto such that the adhesive sheet would not protrude. Next, the polyethylene terephthalate film on the other surface of the adhesive sheet was detached, and the glossy surface side of a copper foil (manufactured by Nippon Denkai, Ltd., trade name: “SLP-18”) having a dimension of 20 mm×20 mm×18 μm (thickness) was pasted thereto such that the adhesive sheet would not protrude. Terminals were connected to the respective approximate centers of the copper foil having a dimension of 100 mm×100 mm and the copper foil having a dimension of 20 mm×20 mm, and the electrostatic capacity (C) was measured using a dielectric constant analyzer (manufactured by Agilent Technologies, Inc, trade name: “LCR meter E4980”) under the conditions of 25° C. and a frequency of 100 kHz, and the electrostatic capacity was substituted for C in the following formula to determine the dielectric constant εᵣ. Here, ε₀ is the dielectric constant in a vacuum, and d is the thickness of the adhesive layer. The evaluation results of the various Examples and Comparative Examples are presented in Table 1.

C=ε₀×εᵣ×(20 mm×20 mm)/d

TABLE 1

| | | | Example | | | | | | | |
|---|---|---|---|---|---|---|---|---|---|---|
| Item | | | 1 | 2 | 3 | 4 | 5 | 6 | 7 | 8 |
| Component (A) | A-1 (Synthesis Example 1) | | 60 | — | 60 | 50 | 60 | 60 | 60 | 60 |
| | A-2 (Synthesis Example 2) | | — | 60 | — | — | — | — | — | — |
| | A-3 (Synthesis Example 3) | | — | — | — | — | — | — | — | — |
| Component (C) | C-1 (Synthesis Example 4) | | 4 | 4 | — | 4 | 2.5 | 4 | 4 | — |
| | C-2 (Synthesis Example 5) | | — | — | 4 | — | — | — | — | — |
| | C-3 (Synthesis Example 6) | | — | — | — | — | — | — | — | — |
| | C-4 (Synthesis Example 7) | | — | — | — | — | — | — | — | 4 |
| | C-5 (Synthesis Example 8) | | — | — | — | — | — | — | — | — |
| | C-6 (Commercially available | | — | — | — | — | — | — | — | — |
| | product) | | | | | | | | | |
| Component (B) | ISTA | | 30.9 | 30.9 | 30.9 | 40.9 | 32.4 | — | 25.9 | 30.9 |
| | STA | | — | — | — | — | — | 30.9 | — | — |
| | 2EHA | | — | — | — | — | — | — | 5 | — |
| | 4HBA | | 5 | 5 | 5 | 5 | 5 | 5 | 5 | 5 |
| Component (D) | I-184 | | 0.1 | 0.1 | 0.1 | 0.1 | 0.1 | 0.1 | 0.1 | 0.1 |
| Film thickness | μm | | 150 | 150 | 150 | 150 | 150 | 150 | 150 | 150 |
| Dynamic | Tg (° C.) | | 37 | 39 | 37 | 40 | 32 | 45 | 30 | 39 |
| viscoelasticity | Storage modulus at 25° C. (Pa) | | 9.3 × 10⁴ | 1.7 × 10⁵ | 9.6 × 10⁴ | 3.2 × 10⁵ | 8.0 × 10⁴ | 1.2 × 10⁵ | 8.2 × 10⁴ | 9.8 × 10⁴ |
| | tan δ | 40° C. | 1.5 | 1.5 | 1.5 | 1.2 | 1.5 | 1.2 | 1.5 | 1.4 |
| | | 80° C. | 1.2 | 1.2 | 1.2 | 1 | 1.7 | 1 | 1.2 | 1.2 |

| | | | | | | | | | |
|---|---|---|---|---|---|---|---|---|---|
| Level difference | Level difference: 80 μm | A | A | A | A | A | B | A | A |
| embeddability | | | | | | | | | |

| Surface flatness | | A | A | A | B | A | B | A | B |
|---|---|---|---|---|---|---|---|---|---|
| Bleeding properties | | A | A | A | A | B | A | B | A |
| Dielectric constant (100 kHz) | | 3 | 2.8 | 3 | 2.8 | 3 | 3 | 3.1 | 3 |
| Optical characteristics | Haze (%) | 0.4 | 0.4 | 0.3 | 0.3 | 0.3 | 0.3 | 0.3 | 0.4 |
| | L* | 100.4 | 100.1 | 100.6 | 100.3 | 100.3 | 100.1 | 100.3 | 100.1 |
| | a* | 0.05 | 0.1 | −0.02 | −0.08 | 0.02 | 0.05 | 0.02 | 0.05 |
| | b* | 0.1 | 0.45 | 0.13 | 0.01 | 0.2 | 0.2 | 0.11 | 0.1 |

| | | Example | | | Comparative Example | | | |
|---|---|---|---|---|---|---|---|---|
| Item | | 9 | 10 | 11 | 1 | 2 | 3 | 4 |
| Component (A) | A-1 (Synthesis Example 1) | 60 | 60 | 60 | — | — | 60 | 60 |
| | A-2 (Synthesis Example 2) | — | — | — | — | — | — | — |
| | A-3 (Synthesis Example 3) | — | — | — | 60 | 60 | — | — |
| Component (C) | C-1 (Synthesis Example 4) | — | — | 4 | — | — | — | — |
| | C-2 (Synthesis Example 5) | — | — | — | — | — | — | — |
| | C-3 (Synthesis Example 6) | — | 2 | — | — | 4 | 4 | — |
| | C-4 (Synthesis Example 7) | — | — | — | — | — | — | — |
| | C-5 (Synthesis Example 8) | — | — | — | 4 | — | — | 4 |
| | C-6 (Commercially available | 0.1 | 0.05 | — | — | — | — | — |
| | product) | | | | | | | |
| Component (B) | ISTA | 34.8 | 32.85 | 35.9 | — | 30.9 | 30.9 | 30.9 |
| | STA | — | — | — | | | | |
| | 2EHA | — | — | — | 30.9 | — | — | — |
| | 4HBA | 5 | 5 | — | 5 | 5 | 5 | 5 |
| Component (D) | I-184 | 0.1 | 0.1 | 0.1 | 0.1 | 0.1 | 0.1 | 0.1 |
| Film thickness | μm | 150 | 150 | 150 | 150 | 150 | 150 | 150 |
| Dynamic | Tg (° C.) | 40 | 36 | 39 | −10 | −12 | 35 | 39 |
| viscoelasticity | Storage modulus at 25° C. (Pa) | 3.4 × 10⁵ | 8.7 × 10⁴ | 1.1 × 10⁵ | 9.7 × 10⁴ | 3.5 × 10⁴ | 8.5 × 10⁴ | 2.3 × 10⁵ |

| | | | | | | | | |
|---|---|---|---|---|---|---|---|---|
| tan δ | 40° C. | 1.2 | 1.4 | 1.2 | 0.5 | 1.6 | 1.5 | 0.5 |
| | 80° C. | 1 | 1.2 | 1 | 0.5 | 1.8 | 1.3 | 0.5 |

| | | | | | | | | |
|---|---|---|---|---|---|---|---|---|
| Level difference | Level difference: 80 μm | B | B | A | B | A | A | C |
| embeddability | | | | | | | | |

| Surface flatness | | B | B | B | C | A | A | C |
|---|---|---|---|---|---|---|---|---|
| Bleeding properties | | A | B | A | A | C | B | A |
| Dielectric constant (100 kHz) | | 3 | 3 | 2.8 | 4.7 | 4.5 | 3.1 | 3.8 |
| Optical characteristics | Haze (%) | 0.4 | 1 | 0.3 | 0.3 | 0.4 | 1.7 | 2.5 |
| | L* | 100.5 | 100.1 | 100.2 | 100 | 100.1 | 95.4 | 94.3 |
| | a* | 0.06 | 0.05 | 0.05 | −0.06 | −0.03 | −0.16 | −0.22 |
| | b* | 0.15 | 0.11 | 0.01 | 0.54 | −0.02 | 1.2 | 1.32 |

### Example 12

[Production of Adhesive Sheet 1 (Four-Layered Product)]

(I) A liquid adhesive resin composition was obtained in the same manner as in Example 1.

(II) This adhesive resin composition was applied on one surface of a heavy-to-release separator 3 to form a coating film, and then a tentative separator 6 was laminated on the coating film. Ultraviolet radiation (400 mJ/cm²) was irradiated thereto, and an acrylic adhesive (manufactured by Hitachi Chemical Co., Ltd., trade name: “HITALEX K-6040”) was laminated on the other surface of the heavy-to-release separator 3. A carrier film 5 was laminated thereon.

(III) The heavy-to-release separator 3, the adhesive layer 2, the tentative separator 6, and the carrier film 5 were cut to a size of 220 mm×180 mm.

(IV) The adhesive layer 2, the heavy-to-release separator 3, and the tentative separator 6 were cut so as to obtain a size of 205 mm×160 mm, using a rotary blade having a diameter of 72 mm. For the cutting, a rotary type punching apparatus equipped with a rotary blade having a diameter of 72 mm was used. At this time, cutting was performed such that the two edges on the longer edge side of the carrier film 5 would protrude out by 7.5 mm from the two edges on the longer edge side of the adhesive layer 2, and the two edges on the shorter edge side of the carrier film 5 would protrude out by 10 mm from the two edges on the shorter edge side of the adhesive layer 2.

(V) The tentative separator 6 was detached, and a light-to-release separator 4 having a size of 215 mm×170 mm was laminated on the adhesive layer 2. In this manner, an adhesive sheet 1 (four-layered product) was obtained. At this time, lamination was performed such that the two edges on the longer edge side of the light-to-release separator 4 would protrude out by 5 mm from the two edges on the longer edge side of the adhesive layer 2, and the two edges on the shorter edge side of the light-to-release separator 4 would protrude out by 5 mm from the two edges on the shorter edge side of the adhesive layer 2.

The adhesive sheet 1 (four-layered product) was subjected to the same evaluations as in the case of the adhesive sheet 1 (three-layered product), and an adhesive sheet having a desired shape could be produced. Furthermore, excellent results were obtained in all of the level difference embeddability, surface flatness, low dielectric constant, and external appearance, as in Example 1.

### INDUSTRIAL APPLICABILITY

According to the present invention, an adhesive sheet for an image display device including an adhesive layer which has excellent transparency, handleability, level difference embeddability and surface flatness, has an appropriate value of dielectric constant, and also has excellent visibility, can be provided. Furthermore, when substrates and other members are bonded together, and then the crosslinking reaction of the adhesive layer is accelerated, the adhesive force and retention power of the adhesive layer itself can be enhanced. Since a device having such an adhesive layer incorporated therein exhibits high reliability, the adhesive sheet of the present invention is appropriate for the use of an image display device. Particularly, the adhesive sheet is highly useful as a sheet material that is used to fill in between an information input device such as a touch panel and a transparent protective plate.

### REFERENCE SIGNS LIST

1 . . . ADHESIVE SHEET, 2 . . . ADHESIVE LAYER, 3 . . . HEAVY-TO-RELEASE SEPARATOR, 4 . . . LIGHT-TO-RELEASE SEPARATOR, 5 . . . CARRIER FILM, 6 . . . TENTATIVE SEPARATOR, 2a, 3a, 4a . . . OUTER EDGES, 3b, 5b . . . SURFACE ON ADHESIVE LAYER SIDE, 3c, 5c . . . INCISION AREA, 10 . . . BASE MATERIAL FILM, B . . . BLADE, 40 . . . TRANSPARENT PROTECTIVE PLATE (GLASS OR PLASTIC SUBSTRATE), 7 . . . IMAGE DISPLAY UNIT, 12 . . . LIQUID CRYSTAL DISPLAY CELL, 20, 22 . . . POLARIZING PLATE, 30 . . . TOUCH PANEL, 31, 32, . . . TRANSPARENT RESIN LAYER, 50 . . . BACKLIGHT SYSTEM, 60 . . . LEVEL DIFFERENCE, 100 . . . JIG

1. An adhesive sheet for an image display device,
the adhesive sheet comprising an adhesive layer; and a pair of substrate layers laminated so as to interpose the adhesive layer therebetween,
wherein the adhesive layer comprises a structural unit derived from stearyl(meth)acrylate as a main component, and has a haze value of 1.5% or less.

2. An adhesive sheet for an image display device,
the adhesive sheet comprising an adhesive layer; a first substrate layer and a second substrate layer laminated so as to interpose the adhesive layer therebetween; and a carrier layer further laminated on the second substrate layer,
wherein the outer edges of the first substrate layer and the carrier layer are protruding outward relative to the outer edges of the adhesive layer, and the adhesive layer contains a structural unit derived from stearyl(meth)acrylate as a main component and has a haze value of 1.5% or less.

3. The adhesive sheet for an image display device according to claim 1, wherein the thickness of the adhesive layer is 1.0×10² μm to 5.0×10² μm.

4. The adhesive sheet for an image display device according to claim 1, wherein the tan δ value at 40° C. to 80° C. of the adhesive layer is 1.2 to 2.

5. The adhesive sheet for an image display device according to claims 1, wherein the adhesive layer is formed from an adhesive resin composition including (A) an acrylic acid derivative polymer, (B) an acrylic acid derivative, (C) a crosslinking agent, and (D) a photopolymerization initiator,
the (A) acrylic acid derivative polymer contains a structural unit derived from stearyl(meth)acrylate, and the (B) acrylic acid derivative comprises stearyl(meth)acrylate.

6. A method for manufacturing an image display device, the method comprising:
a process of bonding adherends using the adhesive layer that is carried by the adhesive sheet for an image display device according to claim 1, and thereby obtaining a laminate;
a process of subjecting the laminate to a heating and pressurization treatment under the conditions of 40° C. to 80° C. and 0.3 MPa to 0.8 MPa; and
a process of irradiating the laminate with ultraviolet radiation through any one side of the adherends.

7. The method for manufacturing an image display device according to claim 6, wherein the adherends are at least two kinds selected from a transparent protective plate, a touch panel, and a liquid crystal display cell.

8. An image display device comprising a laminate, the laminate comprising:
an image display unit; a transparent protective plate; and
an adhesive layer that is disposed between the image display unit and the transparent protective plate, wherein the adhesive layer contains a structural unit derived from stearyl(meth)acrylate as a main component, and has a haze value of 1.5% or less.

9. (canceled)

10. The image display device according to claim 8, wherein the image display unit, the touch panel, or the transparent protective plate has a level difference.

11. The adhesive sheet for an image display device according to claim 2, wherein the thickness of the adhesive layer is 1.0×10² μm to 5.0×10² μm.

12. The adhesive sheet for an image display device according to claims 2, wherein the tan δ value at 40° C. to 80° C. of the adhesive layer is 1.2 to 2.

13. The adhesive sheet for an image display device according to claim 2, wherein the adhesive layer is formed from an adhesive resin composition including (A) an acrylic acid derivative polymer, (B) an acrylic acid derivative, (C) a crosslinking agent, and (D) a photopolymerization initiator,
the (A) acrylic acid derivative polymer contains a structural unit derived from stearyl (meth)acrylate, and the (B) acrylic acid derivative comprises stearyl (meth)acrylate.

14. A method for manufacturing an image display device, the method comprising:
a process of bonding adherends using the adhesive layer that is carried by the adhesive sheet for an image display device according to claim 2, and thereby obtaining a laminate;
a process of subjecting the laminate to a heating and pressurization treatment under the conditions of 40° C. to 80° C. and 0.3 MPa to 0.8 MPa; and
a process of irradiating the laminate with ultraviolet radiation through any one side of the adherends.

15. The method for manufacturing an image display device according to claim 14, wherein the adherends are at least two kinds selected from a transparent protective plate, a touch panel, and a liquid crystal display cell.
